(19) United States
(12) Patent Application Publication
(10) Pub. No.: US 2026/0145415 A1
(43) Pub. Date: May 28, 2026

(54) METHOD AND DEVICE FOR PRODUCING A COMPOSITE BODY

(71) Applicant: Baustoffwerke Gebhart & Soehne GmbH & Co. KG, Lachen (DE)

(72) Inventors: Hans GEBHART, Lachen (DE); Richard MAIER, Lachen (DE)

(21) Appl. No.: 19/121,518

(22) PCT Filed: Oct. 16, 2023
(86) PCT No.: PCT/EP2023/078715

§ 371 Date: Apr. 16, 2025

(30) Foreign Application Priority Data
Oct. 18, 2022 (DE) 10 2022 127 333.4

(51) Int. Cl. B32B 37/12; B32B 7/12; B32B 13/04; B32B 37/10; B32B 37/15; B32B 38/00

(52) U.S. Cl. CPC B32B 37/12; B32B 7/12; B32B 13/04; B32B 37/10; B32B 37/15; B32B 2038/0076; B32B 2250/02

(57) ABSTRACT

The invention relates to a method for producing a composite body (1), having a concrete body (2) and a flat element (3), whereby an underside (3a) of the flat element (3) is adhered to an upper side (2b) of the concrete body (2) by means of an adhesive (4). Thus, an upper side (3b) of the flat element (3) forms an upper side of the composite body (1). The flat element (2) is arranged on a support (14) in such a way that the underside (3a) of the flat element (3) is orientated upwards for application of the adhesive (4), the adhesive (4) is applied automatically to at least one sub-region of the underside (3a) of the flat element (3), and the flat element (3) is then automatically raised off the support (14) and turned in such a way that the underside (3a) of the flat element (3) is orientated downwards. The flat element (3) is moved towards the concrete body (2) and, in this orientation, it is pressed onto the upper side (2b) of the concrete body (2) from above.

The present application claims the priority of German patent application no. 10 2022 127 333.4, the content of which is fully incorporated herein by reference.

The invention relates to a method for producing a composite body which comprises a concrete body and a planar element, whereby a lower side of the planar element is adhesively bonded to an upper side of the concrete body by means of an adhesive, and wherein an upper side of the planar element forms an upper side of the composite body.

The invention furthermore relates to a device for producing a composite body which comprises a concrete body and a planar element, wherein a lower side of the planar element is adhesively bonded to an upper side of the concrete body by means of an adhesive, and an upper side of the planar element forms an upper side of the composite body.

Furthermore, the invention relates to a lifting-and-turning device as claimed in claim 23, to an unpacking station as claimed in claim 24, and to an adhesive application apparatus as claimed in claim 25.

The invention also relates to a composite body as claimed in claim 26.

Natural stone slabs, tiles and ceramic slabs, etc., are known in the general prior art for laying flooring, especially outdoors. It has been demonstrated that particularly tiles and ceramic slabs, especially with higher material thicknesses, meet technical and economic limits, especially in a so-called loose construction mode For efficient technical and economic production, it has proven to be advantageous when the tile or the ceramic slab is used in conjunction with a concrete body.

A generic method and a device for producing a composite body which has a concrete body and a planar element is known from EP 3 216 776B1.

In the generic document it is proposed that an adhesive is applied to a lower side of a solid brick body, or of a ceramic slab, in order to adhesively bond the ceramic slab to a concrete body. For this purpose, the ceramic slab is placed in a casting mold, which is used for manufacturing or producing the concrete body. The ceramic slab should seal conjointly with the side walls of the casting mold. The ceramic slab is placed in the casting mold in such a manner that the upper side of the ceramic slab, which later forms the upper side of the composite body, is oriented downward. The lower side of the ceramic slab on which the adhesive is applied is thus oriented upward. After the ceramic slab is disposed accordingly in the mold, a concrete material is filled into the casting mold. It is proposed to fill the mold in such a manner that a concrete layer with a thickness of 1 to 12 cm, preferably 3 to 8 cm, results. After filling with the concrete material, a compaction, preferably in conjunction with vibration, can take place in a generally known manner. Once the filled concrete material has at least partially cured, in particular to the extent that the concrete body formed by the concrete material is green-stable or has a green-stable state in which the concrete body is dimensionally stable but not yet cured, the composite body formed from the concrete body and the ceramic slab can be removed from the mold and preferably moved into a curing chamber in which a higher temperature prevails. The concrete body can completely harden in the curing chamber.

In EP 3 216 776B1, as an alternative to filling the mold with a pourable concrete material, it is also proposed that a cured concrete body is fed to the ceramic slab placed in the casting mold and provided with an adhesive, and said concrete body is placed on the lower side of the ceramic slab. The cured concrete body herein should exhibit a concrete with a so-called “open structure”. In the generic document it is stated that a concrete with an open structure is suitable for connecting to the adhesive applied to the ceramic slab, since the adhesive can penetrate into the pores of the concrete body. In the generic document, the addition of polymerizable monomers is proposed in order to achieve the penetration of the adhesive into the pores of the concrete body. For this purpose, it is provided that the adhesive applied to the ceramic slab is coated accordingly before the concrete body is placed on the ceramic slab. As a further alternative embodiment, it is proposed that, instead of a cured concrete body on the ceramic slab provided with the polymerizable monomers, a concrete mass is filled onto the coated surface of the ceramic slab.

In terms of the further prior art, reference is also made to EP 3 216 775 B1 which proposes that for adhesively bonding a tile to a concrete body, a primer composition containing monomers forming part of a water-polymerizable polymerization system is used, wherein the primer composition is applied to a surface of the tile and to a surface of the concrete body.

In terms of the further prior art, reference is furthermore also made to EP 3 231 784A1.

In the generic device and the generic method it is disadvantageous that the ceramic slab must be inserted exactly into the casting mold for the concrete body, so that the pourable concrete material can then be applied, or a concrete body with an open structure can be pressed onto the correspondingly positioned ceramic slab.

In the prior art, there is a need for production which is as advantageous as possible in terms of technology and economy, allows a stable connection between the ceramic slab and the concrete body and also withstands the requirements arising from the later use of the composite body, in particular the weather conditions (humidity and temperature), in particular because of the increasing need for composite bodies composed of a ceramic slab and a concrete body.

In order to meet the increasing need for composite bodies which are composed of a concrete body and a planar element, in particular a tile or a ceramic, it would be advantageous when the process steps necessary therefor are optimized and ideally automated. In particular, it is also important to optimize, or to integrate as far as possible, the process steps as optimally as possible with the methods and devices known from the prior art for the production of a concrete body which is a constituent part of the composite body. The present invention is based on the object of achieving a method for producing a composite body which has a concrete body and a planar element, by means of which a solid and permanent connection between the concrete body and the planar element is created, and which is technically and economically advantageously implementable.

This object is achieved according to the invention by the features of claim 1.

The present invention is also based on the object of achieving a device for producing a composite body which has a concrete body and a planar element, by means of which a solid and permanent connection between the concrete body and the planar element can be established.

This object is achieved according to the invention by the features of claim 14.

The present invention is furthermore based on the object of providing a composite body of a concrete body and a planar element which is economically and technically advantageously produced and in which the concrete body is fixedly and permanently connected to the planar element.

A composite body of this type is provided by the features of claim 25.

The present invention is furthermore based on the object of achieving a lifting-and-turning apparatus, in particular for use in a method and/or a device for producing a composite body by means of which planar elements which rest on a support surface can be picked up in a particularly advantageous manner.

A lifting-and-turning apparatus of this type is provided by the features of claim 23.

The present invention is furthermore based on the object of achieving an unpacking station, in particular for use in a method and/or a device for producing a composite body, by means of which a pack with planar elements can be unpacked in a particularly advantageous manner.

An unpacking station of this type is provided by the features of claim 24.

The present invention is furthermore based on the object of achieving an adhesive application apparatus, in particular for use in a method and/or a device for producing a composite body, by means of which an adhesive can be applied to a lower side of a planar element in a particularly advantageous manner.

An adhesive application apparatus of this type is provided by the features of claim 25.

The method according to the invention for producing a composite body which has a concrete body and a planar element provides that a lower side of the planar element is adhesively bonded to an upper side of the concrete body by means of an adhesive. The upper side of the planar element forms the upper side of the composite body.

According to the invention, it is provided that the planar element is disposed on a support surface in such a manner that the lower side of the planar element is oriented upward for applying the adhesive, whereupon an adhesive is applied in an automated manner to at least a sub-region of the lower side of the planar element, and the planar element is subsequently lifted in an automated manner from the support surface and turned over in such a manner that the lower side of the planar element is oriented downward, whereupon the planar element is moved to the concrete body and is in this orientation pressed onto the upper side of the concrete body from above.

The inventors have recognized that a particularly advantageous method for producing a composite body is derived when, in contrast to the teaching from the prior art, the planar element is moved to the concrete body and is pressed onto the upper side of the concrete body from above, wherein it is provided for this purpose that the lower side of the planar element is prepared accordingly beforehand, i.e. that an adhesive is applied in an automated manner at least to at least a sub-region of the lower side of the planar element, and the planar element is subsequently lifted in an automated manner from the support surface and turned over in such a manner that the lower side of the planar element is oriented downward. This sequence has proven to be advantageous compared to moving the concrete body to the planar element, and can be in particular also integrated particularly advantageously into the concrete block production.

It has proven to be suitable or sufficient if the adhesive is applied to at least a sub-region of the lower side of the planar element. Although it can be provided in principle that the adhesive is applied completely to the lower side of the planar element, this is not mandatory for producing a solid and permanent connection between the planar element and the concrete body and is not necessarily advantageous either, as will yet be explained in more detail hereunder.

It has furthermore proven advantageous in the context of the method according to the invention when the adhesive is applied only to the lower side of the planar element and not additionally to the upper side of the concrete body provided for adhesively bonding to the planar element. In contrast to the teaching according to EP 3 216 775B1, it is considered advantageous in the present case when the adhesive is applied only on one side, i.e. when the adhesive is applied only to at least a sub-region of the lower side of the planar element.

The method according to the invention is not only suitable for connecting a concrete body to a tile body or a ceramic slab, but it has been demonstrated that the method is suitable for connecting a concrete body to any planar element which is preferably formed from a further material, or a material dissimilar from the concrete body.

In the context of the invention, a composite body is a body which, in addition to the concrete body, has at least one planar element which is preferably formed from a further material.

The composite body is preferably a composite stone which is formed from the concrete body and a planar element, in particular a slab.

According to the invention, it can be provided that the planar element is formed as a slab, in particular as a ceramic slab, rubber slab, vinyl slab, checker board, stainless steel slab or metal slab, in particular having a structured upper side and/or as a tile, as natural stone or as a laminate.

The method according to the invention is particularly suitable when the planar element is formed as a ceramic slab, in particular as a tile.

The composite bodies according to the invention preferably have vertically extending spacers which are formed by the concrete body, in a manner fundamentally known. Such spacers are known, for example, from EP 2 401 432B1.

According to the invention, it can also be provided that a mineral adhesive is used as the adhesive.

It has been demonstrated that the use of a mineral adhesive allows a particularly strong and permanently reliable connection between the planar element and the concrete body to be achieved.

It is advantageous when the pressing of the planar element on the concrete body is carried out in a green-stable state of the concrete body, in which the concrete body is dimensionally stable but not yet cured.

In the prior art, a concrete body in the green-stable state is also referred to as a “green” concrete blank. The green-stable state of the concrete body means that the concrete body is already sufficiently cured to retain its shape when the concrete body leaves the production mold or the casting mold or the filling mold, or when the concrete body would be removed from the mold.

The planar element provided with the adhesive is preferably pressed onto the upper side of the concrete body when the latter is still moist.

It has been demonstrated that this method can achieve a solid connection between the planar element and the concrete body, which is also permanently reliable in relation to weather conditions, in particular with regard to moisture and temperature fluctuations.

According to the invention, it can also be provided that the planar element is moved so as to be plane-parallel and/or orthogonal relative to the upper side of the concrete body during pressing onto the concrete body.

It has proven to be particularly advantageous when the planar element is moved so as to be plane-parallel and/or orthogonal (vertical) relative to the upper side of the concrete body during pressing onto the concrete body. Preferably, it is provided in the process that, for this purpose, the planar element is moved during pressing onto the concrete body. However, it is fundamentally also possible to move the concrete body or to move both elements while pressing the planar element onto the concrete body.

In the context of the method according to the invention, it has proven to be particularly advantageous when the concrete body is not moved while pressing the planar element, but the plane-parallel and/or orthogonal movement, preferably an oscillating and/or vibrating movement, is generated only by the planar element.

It has been demonstrated that by moving the planar element during pressing onto the concrete body, the adhesive can be activated in a particularly advantageous manner and a solid and reliable connection between the planar element and the concrete body can be established.

In contrast to the prior art, in which compaction and vibration is provided only after filling the concrete material into the casting mold in which the planar element is located, it has proven to be advantageous when the planar element is moved so as to be plane-parallel and/or orthogonal relative to the upper side of the concrete body while pressing the planar element onto the concrete body.

It is advantageous when the planar element is moved so as to vibrate and/or oscillate relative to the upper side of the concrete body during pressing.

It has been found to be particularly suitable when the planar element is moved so as to vibrate and/or oscillate relative to the upper side during pressing.

The vibration and/or the oscillation takes place at such an intensity that the preferably green-stable concrete body or its shape is not destroyed.

It has proven to be particularly advantageous when the vibrating and/or oscillating movement has an amplitude of less than 3 mm.

A movement of the planar element relative to the upper side of the concrete body has proven to be particularly suitable for activating the adhesive and for producing a solid and permanent connection.

It has been demonstrated that by pressing the planar element onto the concrete body, the adhesive is distributed in a suitable manner and the adhesive is connected to the concrete body in a particularly advantageous manner by the vibration and/or the oscillation, in particular also penetrates into pores of the concrete body.

It has been demonstrated that a particularly advantageous composite body can be produced when the concrete body has a water/cement content (water cement value abbreviated: w/z value) of 0.25 to 0.45, i.e. a proportion of water between 25% and 45% of the proportion by weight of the cement, when the planar element is pressed onto the concrete body; in particular, a water/cement content of 0.35 to 0.45 has proven to be particularly suitable.

It has been demonstrated that a particularly advantageous composite body can be produced when the concrete body has a water/binder content (water binder value abbreviated: w/b value) of 0.25 to 0.45, i.e. a proportion of water between 25% and 45% of the proportion by weight of the binder, when the planar element is pressed onto the concrete body; in particular, a water/binder proportion of 0.35 to 0.45 has proven to be particularly suitable.

It has proven to be advantageous when the concrete body has 10% to 25% natural sand of 0 to 4 mm, preferably 14% to 22%, in particular 16% to 20% natural sand of 0 to 4 mm.

It has also proven to be particularly suitable when the adhesive is applied to, and/or sprayed onto, the lower side of the planar element in an automated manner.

It is advantageous when the adhesive is applied in portions to the lower side of the planar element, preferably while omitting an encircling periphery of the lower side of the planar element.

It can be provided within the scope of the method according to the invention that the adhesive is applied completely to the entire lower side of the planar element. However, it has proven to be advantageous when the adhesive is not applied completely, but preferably only in portions, or to a sub-region, of the lower side, preferably in portions over the entire lower side. It has proven to be particularly suitable when an encircling periphery of the lower side of the planar element is omitted, i.e. an adhesive is applied only to a sub-region of the lower side. It has proven to be advantageous when no adhesive is squeezed out over the periphery of the lower side of the planar element when pressing the planar element onto the concrete body. This can be advantageously achievable, for example, in that an encircling periphery of the lower side of the planar element is omitted when applying the adhesive, or the adhesive already applied there is wiped off again.

It is advantageous when the planar element is transported below an adhesive application apparatus in such a manner that the adhesive is applied from above, preferably with a toothed spatula structure on the lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction.

It has been demonstrated that the adhesive is applied in a particularly advantageous manner to the lower side of the planar element as a result of the planar element being transported below an adhesive application apparatus. The adhesive application apparatus can preferably comprise an adhesive filling carriage or consist of the latter.

The adhesive application apparatus can be designed in such a manner, in particular have a corresponding dispensing opening, e.g. a dispensing slot, through which it is possible to apply the adhesive preferably with a toothed spatula structure over part of the area, preferably in portions over the entire lower side, particularly preferably while omitting an encircling periphery, on the lower side of the planar element.

The adhesive application apparatus, in particular the adhesive filling carriage, preferably has a dispensing opening for the adhesive, the longitudinal axis thereof extending orthogonally to the feed direction of the planar elements. Alternatively or additionally to the fact that the planar elements are transported below the adhesive application apparatus, it can also be provided that the adhesive application apparatus is displaceable in such a way that the adhesive application apparatus and the planar element are moved relative to one other in such a manner that the planar element is transported below the adhesive application apparatus, in particular the dispensing opening for the adhesive.

Further advantageous measures by way of which it can be achieved that no adhesive escapes when pressing the planar element onto the concrete body are shown below in yet more detail, wherein these measures can also be used in combination with and/or as alternatives to omitting or wiping off an encircling peripheral region, so that no adhesive is present thereon during pressing onto the concrete body.

With the aid of the wiping element, adhesive already applied to the lower side of the planar element can be wiped off a peripheral region (proceeding from the respectively assigned edge). This has proven to be advantageous with a view to the later adhesive bonding of the planar element to the concrete body.

It is advantageous when the adhesive is applied with a toothed spatula structure to the lower side of the planar element, wherein the adhesive is preferably applied in such a manner that the adhesive has a thickness of 3 mm to 10 mm, preferably 4 mm to 8 mm, in particular 5 mm to 7 mm, in those regions in which it has a greater thickness on the lower side of the planar element.

It has proven to be particularly advantageous when the adhesive is applied with a toothed spatula structure. It can be provided in the process that the toothed spatula structure is designed in such a manner that an adhesive is provided both in the heights (elevations) and in the depths of the structure resulting from the toothed spatula. However, it has proven to be particularly advantageous that no adhesive is provided in the trenches of the toothed spatula structure. By pressing the planar element onto the upper side of the concrete body, the adhesive is then preferably distributed completely on the lower side of the planar element, preferably while omitting an encircling periphery.

According to the invention, it can be provided that the upper side of the concrete body is structured, in particular roughened, and/or provided with grooves and/or with ribs and/or a toothed spatula structure, prior to pressing the planar element.

For the production of a solid and permanently reliable connection between the planar element and the concrete body, it has proven to be particularly suitable when the upper side of the concrete body is structured, in particular roughened, before pressing the planar element. In addition or alternatively, it can also be provided that grooves and/or ribs are inserted into the upper side of the concrete body and/or the upper side of the concrete body has a toothed spatula structure. The above-mentioned design embodiment of the upper side of the concrete body before pressing the planar element can be provided alternatively to, but also effected in conjunction with, the fact that the adhesive is applied with a toothed spatula structure to the lower side of the planar element.

It is advantageous when the upper side of the concrete body is structured by a punch pressed on the upper side of the concrete body in the production of the concrete body, preferably by a punch used for compacting the concrete body.

It has proven to be particularly suitable to achieve the structuring and/or the grooves and/or the ribs and/or the toothed spatula structure in the upper side of the concrete body in that the upper side of the concrete body is structured by a punch pressed on the upper side of the concrete body in the production of the concrete body. Preferably, the punch which is used in a fundamentally known manner for compacting the concrete body can be used for this purpose. Such a punch is typically pressed onto the concrete body for compacting the concrete body when the latter is still in the casting mold.

According to the invention, it can furthermore be provided that the peripheral region of the upper side of the concrete body, preferably so as to encircle the upper side of the concrete body, is provided with pockets and/or depressions and/or indentations and/or a chamfer, which are or is suitable to absorb adhesive that has been displaced by pressing the planar element.

It has proven to be particularly advantageous when the upper side of the concrete body has pockets and/or depressions and/or indentations and/or a chamfer which are or is suitable to absorb adhesive that has been displaced by pressing the planar element. The pockets, depressions, indentations or the chamfer can thus serve as a reservoir to absorb adhesive that is displaced when the planar element is pressed onto the concrete body.

It is advantageous when the pockets and/or the depressions and/or the indentations and/or the chamfer are or is incorporated by a punch pressed in the production of the concrete body on the upper side of the concrete body, preferably a punch, which is used for compacting the concrete body.

It has proven to be particularly suitable when the pockets and/or the depressions and/or the indentations and/or the chamfer are already incorporated into the concrete body during the production of the latter, in particular in that a punch is pressed onto the upper side of the concrete body. Preferably, as already described above with regard to the structuring, a punch can be used for this purpose, which is anyway used for compacting the concrete body at a time when the concrete body is still in the casting mold or a production mold, in particular a casting mold of a production mold, wherein the punch serves to compact the concrete body in a fundamentally known manner.

The casting molds of a production mold are also referred to as formwork molds.

According to the invention, it can be provided that the position of the concrete body is determined, preferably measured, before pressing the planar element.

Methods can be used for this purpose in a manner fundamentally known. The position can be determined in particular also with the aid of optical sensors. In contrast to the solution, which is known from the generic document and in which the tile is in a defined position within the casting mold, it is advantageous in terms of automated production of the composite body when the position of the concrete body is determined before pressing on the planar element, in order that a high production quality can be achieved.

It is advantageous when the position of an entire production layer of concrete bodies is measured, preferably in that two diagonally opposite corner points of the production layer are measured.

It has proven to be particularly efficient if the position of an entire production layer of concrete bodies is measured. The production layer is preferably defined by a production mold which is used in the production of the concrete bodies and is filled into the concrete mass for forming the concrete bodies. The production mold can optionally have only one casting mold which in this instance corresponds to the production mold, or, however, the production mold has a plurality of casting molds which in this instance preferably define a production layer of the concrete bodies.

Measuring a production layer can preferably be carried out in that two diagonally opposite corner points of the production layer are measured, or their position is determined. The position of all concrete bodies in the production layer can then be determined or derived from the position of said corner points. The position of the concrete bodies of a production layer relative to one other, after the concrete bodies have left the casting mold, is usually not arbitrary, but results from the casting mold, or can be derived from it. It has been demonstrated that it is sufficient when two diagonally opposite corner points of the production layer are measured or determined by corresponding sensors.

For measuring a single concrete body, but in particular for measuring the entire production layer, corresponding measuring instruments can be used within the context of the method according to the invention, in particular optical sensors which measure the entire layer at once, preferably in that opposite points or corner points of the production layer are measured. The position and the orientation of the production layer are preferably determined by ascertaining only two points.

According to the invention, it can furthermore be provided that the lower side of the planar element is cleaned of dust before applying the adhesive, in particular blown off and/or brushed off.

It has proven to be particularly suitable when the lower side of the planar element is cleaned of dust before applying the adhesive. Blowing-off or brushing-off has proven to be particularly suitable for this purpose. In particular tiles or ceramic slabs are usually sanded, so that dust is located on the tile or the ceramic slab. With the aid of a blower or a brushing tool, dust of this type can be particularly advantageously removed, whereby the adhesive bond between the planar element and the concrete body is im-proved.

According to the invention, it can furthermore be provided that the concrete body after adhesively bonding the planar element is fed to a curing area, preferably a curing chamber, which has a higher temperature and in which the concrete body cures.

It has proven to be particularly suitable when the concrete body after adhesively bonding the planar element, thus the composite body produced in this way, is fed to a curing area, preferably a curing chamber. In the curing area or the curing chamber, the concrete body can then accordingly cure, in particular if this is a concrete body that has not yet cured. It has also been demonstrated that this measure also improves the connection between the planar element and the concrete body, or the hardening of the adhesive.

It is advantageous when the dimensions of the lower side of the planar element correspond substantially to the dimensions of the upper side of the concrete body, wherein preferably the extent of the upper side of the planar element in a longitudinal direction and a width direction is in each case 1 mm to 40 mm, preferably 2 mm to 30 mm, in particular 3 mm to 20 mm, particularly preferably 4 mm to 10 mm, less than an extent of the upper side of the concrete body in the respective direction.

The aforementioned dimensions have proven to be particularly suitable for producing a composite body. In particular, it has proven to be suitable when the extent of the planar element in a longitudinal direction and a width direction is less than an extent of the upper side of the concrete body in the respective direction.

It can be advantageous when the planar element is adhesively bonded to the concrete body while the concrete body is still in a production mold or a casting mold in which the concrete body is compacted, or the planar element is adhesively bonded to the concrete body after the concrete body has left a production mold or a casting mold in which the concrete body is compacted.

It has proven to be particularly advantageous when the planar element is only adhesively bonded to the concrete body when the concrete body has left the production mold or the casting mold in which the concrete body is compacted. In this case, this is preferably a green-stable concrete body, or a freshly completed and already demolded concrete body, or concrete brick. The concrete body is therefore located outside the production mold or the casting mold. However, the concrete body has preferably not yet cured, or is preferably not yet in the curing area or the curing chamber. In this state, the planar element can be applied in a particularly suitable manner, both technically and economically.

Alternatively, however, it is also possible that the planar element is adhesively bonded to the concrete body while the concrete body is still in the production mold or the casting mold in which the concrete body is compacted. The concrete body has already been compacted, so the concrete body is in a green-stable state, but still in the production mold or the casting mold. It can be particularly suitable for special applications that the planar element is adhesively bonded to the concrete body in this state of the latter. An advantage of applying the planar element to the concrete body while it is still in the production mold or the casting mold can lie in that the planar element can be placed precisely, since the position of the concrete body in the production mold or the casting mold is still precisely predefined. However, pressing and positioning the planar element requires more time than when the concrete body has already left the production mold or the casting mold.

It is advantageous when the planar element is adhesively bonded to the concrete body in a state in which it is already dimensionally stable, meaning after the completion of the main compaction process, but has not yet completely cured. Preferably, the concrete body here is no longer in the production mold or the casting mold in which it was compacted.

According to the invention, it can be provided that after the adhesive has been applied to the lower side of the planar element and the planar element has been turned over in such a manner that the lower side of the planar element is oriented downward, the planar element is picked up by a feeding apparatus, in particular a multi-axis robot, in particular a 6-axis robot, moved to the concrete body and pressed onto the concrete body.

It has proven to be particularly suitable if, after the planar element has been turned in such a manner that the lower side of the planar element provided with the adhesive is oriented downward, said planar element is picked up by a feeding apparatus, in particular a multi-axis robot, and moved in one operational step to the concrete body and pressed onto the upper side of the concrete body, with the aid of the feeding apparatus, in particular the multi-axis robot. For this purpose, it is preferably provided that a concrete body provisioning apparatus in which the concrete bodies, preferably in a green-stable state, are located and the unit, preferably a lifting-and-turning unit, which lifts and turns the planar element after the application of the adhesive, are positioned spatially relative to one another, preferably directly adjacent, in such a manner that the feeding apparatus, in particular the multi-axis robot, can pick up the planar element and press it onto the upper side of one of the concrete bodies.

According to the invention, it can also be provided that the planar element is provided as part of a pack of similar planar elements which are disposed stacked on top of one another conjointly in a packaging, whereupon the pack, preferably by means of a third multi-axis robot, in particular a 6-axis robot, is placed on an unpacking station, whereupon the packaging is cut open and removed in the unpacking station, and the respectively uppermost planar element is removed, preferably by means of an onward transport apparatus, in particular a first multi-axis robot, in particular a 6-axis robot, and is placed on the support surface, preferably a conveyor belt, in such a manner that the lower side of the planar element is oriented upward.

It has proven to be particularly suitable for technically and economically advantageous production of the composite body when the planar element is provided as part of a pack of similar planar elements which are disposed conjointly in a packaging. The planar elements can preferably be tiles or ceramics, and the pack can be a tile pack or a ceramic pack. In the process, the pack can be placed, preferably in an automated manner, on the unpacking station by means of an onward transport apparatus, preferably a multi-axis robot, in particular a 6-axis robot. In the unpacking station, the packaging can then be cut open and removed, preferably in an automated manner.

The packaging is preferably a cardboard packaging.

Cutting open the packaging in the unpacking station is preferably carried out in such a manner that the packaging is cut at the lower side of the pack in the direction of the vertically extending corners of the pack (wherein the vertically extending corners extend orthogonally to the upper side or lower side of the planar elements). For this purpose, the packing station can preferably have four cutting tools, preferably knives. Preferably, the packaging is cut along the lower side of the pack at least up to, preferably up to, the vertically extending corners. The unpacking station can also have a support surface or a platform on which a pack of the planar elements, which are still in the packaging, is placed. Preferably, the unpacking station has a vacuum apparatus which is suitable to attract the pack or to hold the latter on the support surface. Alternatively or additionally, it can be provided that the third multi-axis robot holds the pack in position during the cutting of the packaging.

The cut-off packaging is preferably removed by means of the third multi-axis robot and transported to a collection point, e.g. a transport cart. The third multi-axis robot preferably has receptacle elements, e.g. suction cups, for this purpose.

After the packaging has been removed, the respectively uppermost planar element can be removed and placed on the support surface in such a manner that the lower side of the planar element is oriented upward. An adhesive can then be applied to at least a sub-region of the lower side of the planar element.

Preferably, the support surface is a conveyor belt which transports the planar element below the adhesive application apparatus.

A multi-axis robot, in particular a 6-axis robot, can preferably be provided for picking up the respectively uppermost planar element from the packing station. A multi-axis robot has proven to be particularly suitable for picking up the respectively uppermost planar element of a pack lying on the unpacking station, and for placing said element on the support surface.

Preferably, the pack of planar elements still in a packaging is placed on the unpacking station in such a manner that the lower side of the planar elements is oriented upward. In this orientation, the multi-axis robot can pick up the respectively uppermost planar element in a particularly simple way and place it on the support surface without the need to turn over the planar element. Preferably however, the onward transport apparatus, in particular the first multi-axis robot is designed to turn over the planar element as required, in particular because the planar elements in a pack can be disposed in different orientations (in particular lower side on lower side, or upper side on upper side), so that at least some of the planar elements of a pack must be turned over.

Preferably, two or more unpacking stations are provided. The method herein is preferably carried out in such a manner that the onward transport apparatus, in particular the first multi-axis robot, removes the planar elements from an unpacking station while the third multi-axis robot places them on another unpacking station and preferably facilitates a removal of the packaging.

An advantageous device according to the invention for producing a composite body is defined in claim 14.

The device according to the invention for producing a composite body which comprises a composite body and a planar element, wherein a lower side of the planar element is adhesively bonded to an upper side of the concrete body by means of an adhesive, and an upper side of the planar element forms an upper side of the composite body, has a support surface on which the planar element is disposed in such a manner that the lower side of the planar element is oriented upward. The device according to the invention furthermore has an adhesive application apparatus which subsequently applies an adhesive to at least a sub-region of the upwardly oriented lower side of the planar element. The device according to the invention furthermore has a lifting-and-turning device to subsequently lift the planar element from the support surface and to turn it in such a manner that the lower side of the planar element is oriented downward. The device according to the invention furthermore has a feeding apparatus in order to subsequently move the planar element provided with the adhesive to the concrete body, and to press the lower side of the planar element onto the upper side of the concrete body.

The device according to the invention enables particularly advantageous production of a composite body which has a concrete body and a planar element.

It has been demonstrated that, with a view to a technically and economically advantageous production of the composite body, it is advantageous when the device has a support surface on which the planar element can be disposed in such a manner that the lower side of the planar element is oriented upward. In this orientation of the planar element, the adhesive application apparatus can apply an adhesive in a particularly simple manner to at least a sub-region of the lower side of the planar element.

A cycle time of 3 seconds to 10 seconds, preferably 4 seconds to 6 seconds, is preferably provided for applying the adhesive.

It has further proven to be advantageous when the device has a lifting-and-turning apparatus for both lifting the planar element and turning it after the application of the adhesive to the lower side of the planar element in such a manner that the lower side of the planar element is oriented downward. In this orientation, the planar element can then be picked up in a particularly advantageous manner by the feeding apparatus of the device, moved to the concrete body and pressed onto the upper side of the concrete body. The device according to the invention enables effective production of the composite body and can also be integrated in a particularly advantageous manner in the production process of the concrete body or the usual production process of the concrete body, and the usual concrete body production apparatus can remain unchanged.

According to the invention, it can furthermore be provided that a concrete body provisioning apparatus is provided, in which the concrete body is preferably in a green-stable state in which the concrete body is dimensionally stable, but not yet cured, and wherein the feeding apparatus is positioned relative to the lifting-and-turning apparatus and the concrete body provisioning device in such a manner that the planar element is able to be picked up by the feeding apparatus from the lifting-and-turning device and can be pressed from above onto the, preferably green-stable, concrete body provided by the concrete body provisioning apparatus.

The concrete body, on which the planar element is pressed, is preferably located in a concrete body provisioning apparatus, in which the concrete body is preferably in a green-stable state.

The feeding apparatus and the concrete body provisioning apparatus are preferably positioned relative to one another in such a manner that the planar element can be pressed onto the concrete body, preferably in one operational step. The feeding apparatus can preferably comprise a multi-axis robot, preferably a 6-axis robot, or be designed as such.

The concrete body provisioning apparatus can obtain the concrete bodies, preferably a production layer of concrete bodies, from a concrete body production apparatus. The concrete bodies can still be in the production mold or a casting mold of the production mold, or have preferably already been removed from the production mold or a casting mold of the production mold. The production of the concrete bodies in the concrete body production plant can take place fundamentally in a known manner. The device according to the invention can thus also be combined in a particularly advantageous manner with already existing concrete body production apparatuses in which it is provided that a pourable concrete material is filled into a production mold or a casting mold.

It is advantageous when an activation apparatus is provided, which moves the planar element relative to the upper side of the concrete body during pressing onto the concrete body, in order to activate the adhesive It has proven to be particularly suitable when the planar element is moved relative to the upper side of the concrete body during pressing onto the concrete body. In principle however, it is also possible that the concrete body onto which the planar element is pressed is moved during the pressing. It is also possible that the device is designed in such a manner that both the planar element and the concrete body are moved when pressing the planar element onto the concrete body.

The activation apparatus can preferably comprise a vibration apparatus and/or an oscillation apparatus, which cause the planar element to vibrate or oscillate relative, preferably substantially plane-parallel and/or orthogonal, to the upper side of the concrete body.

It has been demonstrated that the adhesive bond between the concrete body and the planar element be-comes particularly positive when the planar element is pressed onto the upper side of the concrete body using a slight vibration.

It is advantageous when a lower side of a punch, provided for compacting the concrete body, of a concrete body production apparatus is designed in such a manner that the punch structures, in particular roughens, the upper side of the concrete body, and/or the punch incorporates pockets and/or depressions and/or indentations and/or a chamfer into the peripheral region of the upper side of the concrete body.

It has been demonstrated that a design embodiment of the upper side of the concrete body in such a manner that it is structured, in particular roughened, leads to the planar element being able to be bonded particularly well to the concrete body. Furthermore, it has been demonstrated that it can also be advantageous when pockets and/or depressions and/or indentations and/or a chamfer are incorporated into the peripheral region of the upper side of the concrete body. The pockets, depressions, indentations or the chamfer can in particular serve as a reservoir to absorb material of the adhesive when it is displaced by the planar element being pressed. The pockets, depressions, indentations and/or the chamfer are preferably designed in such a manner that the adhesive is not squeezed out beyond the upper side of the concrete body.

Both the structuring and the pockets, the depressions, the indentations or the chamfer can preferably be inserted with a punch which is pressed onto the upper side of the concrete body before the concrete body is completely cured. It is advantageous when the punch of a concrete body production apparatus is used, which is present anyway to compact the concrete body during production in the production mold.

The chamfer, which is incorporated on the periphery of the concrete body into the upper side of the concrete body, can preferably have a width (extent plane-parallel to the upper side) of 2 mm to 8 mm and a depth (extent orthogonal to the upper side) of 2 mm to 8 mm, particularly preferably a width of 5 mm and a depth of 5 mm.

According to the invention, it can be provided that a cleaning apparatus is provided for cleaning the lower side of the planar element before applying the adhesive and/or the upper side of the concrete body before pressing the planar element, in particular for blowing off or brushing off dust.

It has proven to be particularly suitable when a cleaning apparatus is provided, which is designed in such a manner that the lower side of the planar element can be cleaned before applying the adhesive, in particular to blow or brush dust off said lower side. For this purpose, the cleaning apparatus can be designed as a blower or as a brushing tool, for example as a rotating brush, or comprise a blower or a brushing tool. Alternatively or additionally, the cleaning apparatus can also be designed in such a manner that the upper side of the concrete body can be cleaned before pressing the planar element, in particular to blow or brush dust off said upper side. For this purpose, the cleaning apparatus can again be designed as a blower or as a brushing tool, for example as a rotating brush, or have a blower or a brushing tool.

The cleaning apparatus can in particular also be formed in two parts, or have two or more cleaning modules to clean both the lower side of the planar element and the upper side of the concrete body.

According to the invention, a measuring apparatus can also be provided to determine, in particular measure, the position of the concrete body on the concrete body provisioning apparatus.

It has proven to be advantageous when the device according to the invention comprises a measuring apparatus which, with the aid of sensors, preferably optical sensors, determines or measures the position of the concrete body onto which the planar element is pressed. It can also be provided that the measuring apparatus is designed to determine, in particular measure, the position of an entire production layer of concrete bodies. For this purpose, it can be sufficient if the measuring apparatus determines or measures the position of two defined points of the production layer, for example two diagonally opposite corners, so that, supported by a computing device, the position of the individual concrete bodies of the production layer can be determined or calculated accordingly. This is possible because the position of the individual concrete bodies of a production layer relative to one another is typically known, or determined by the production mold.

According to the invention, a curing area, in particular a curing chamber, can be provided, which has a higher temperature and into which the composite body can be moved after the planar element is adhesively bonded to the concrete body.

It has proven to be advantageous when the concrete body or the composite body is not moved into a curing area, in particular a curing chamber, or a drying chamber, in which a higher temperature prevails, in particular a higher temperature than in the concrete body provision apparatus, until after the planar element is applied or adhesively bonded to the concrete body, so that the preferably green-stable concrete body or the green concrete body and/or the adhesive can cure. Such curing chambers or drying chambers are fundamentally known from the prior art. In particular, high-bay warehouses are suitable as drying chambers.

It is advantageous when the planar element is a slab, in particular a ceramic slab, a rubber slab, a vinyl slab, a checker board, a stainless steel slab or a metal slab, in particular having a structured upper side, and/or the planar element is a tile, a natural stone or a laminate.

It has been demonstrated that any slabs, in particular ceramic slabs or tiles, can be connected to a concrete body in a particularly advantageous manner by means of the device according to the invention.

However, the device according to the invention is also particularly suitable for connecting a planar element, which is a rubber slab, a vinyl slab, a checker board, a stainless steel slab or a metal slab, in particular having a structured upper side, a natural stone or a laminate, to a concrete body.

It has proven to be particularly suitable when the adhesive is a mineral adhesive.

It has been demonstrated that a planar element can be particularly advantageously connected to a concrete body, preferably a green-stable concrete body, by means of a mineral adhesive.

It has been demonstrated that when the planar element is adhesively bonded to the concrete body in a green-stable state, i.e. in a state in which the concrete body is still “wet”, less adhesive is required. In this case, it can be already sufficient if the adhesive has a thickness or height or vertical measurement of 1 mm.

It has also been demonstrated that the prior cleaning of the concrete body and/or the planar element of dust significantly improves the adhesive bond and in particular leads to the fact that less adhesive is required.

It has also been demonstrated that talc on the planar element, especially if the latter is a ceramic, is disadvantageous when adhesively bonding on the lower side of the planar element. It can therefore be advantageous to remove talc before applying the adhesive to the lower side of the planar element preferably by a mechanical action, in particular tapping, striking or brushing. Here, the use of a device for aging concrete blocks, as is known in particular from EP 1 893 391B1, can be advantageous. The impactors can act on the lower side of the planar element. Instead of the paving stones to be aged, the planar elements, in particular ceramic slabs, to be freed from talc can be transported below the impactors. The device according to EP 1 893 391 B1 can be operated as described for the aging of the paving stones.

It has further proven to be advantageous when the two faces to be bonded to one other have a rough surface. The upper side of the concrete body has already proven fundamentally to be suitable for this purpose. In order to achieve a roughness also at the lower side of the planar element, it can in turn be advantageous when the lower side of the planar element was treated or roughened with a method or a device according to EP 1 893 391 B1 before the application of the adhesive.

It is advantageous when the concrete body has lateral spacers which are formed on the side walls of the concrete body and extend at least over part of the height of the side walls from the direction of the lower side of the concrete body toward the upper side of the concrete body. The spacers preferably extend in a direction orthogonal to the lower side or upper side of the concrete body.

It can be sufficient when the spacers are designed in the manner of a bead and have a width or thickness of 1 mm to 5 mm, preferably 1 mm to 2 mm.

According to the invention, it can be provided that for applying the adhesive to the lower side of the planar element, the support surface and the adhesive application apparatus are designed to transport the planar element below the adhesive application apparatus and in the process to apply the adhesive to the upwardly oriented lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction. The wiper element can be designed as a bulkhead.

It has been demonstrated that by a relative movement of the support surface and the adhesive application apparatus to one other in such a manner that the planar element lying on the support surface is transported below the adhesive application apparatus, the adhesive is able to be applied to the upwardly oriented lower side of the planar element in a particularly advantageous manner.

The adhesive application apparatus can have a dispensing opening which preferably extends so as to be orthogonal to the direction of movement by which the planar element is transported below the adhesive application apparatus. The dispensing opening preferably extends over the entire width (=extent transverse to the feed direction) of the planar element to be transported below the adhesive application apparatus. It can also be provided here that the extent of the dispensing opening transverse to the feed direction is 10 mm to 50 mm smaller than the width of the planar element, and the planar element is guided below the dispensing opening in such a manner that the two peripheral regions of the lower side of the planar element, which extend in the longitudinal direction (=extent along the feed direction), are not provided with adhesive. The peripheral regions herein, proceeding from the respectively adjacent edges, have a depth of preferably 5 mm to 25 mm.

It has proven to be advantageous when the support surface transports the planar element below the adhesive application apparatus. Alternatively or additionally, the adhesive application apparatus can also be designed in such a manner that it can be moved in or counter to the feed direction of the planar elements.

It is advantageous when the support surface is designed as a transport belt or conveyor belt in order to transport the planar elements below the adhesive application apparatus.

It has been demonstrated that it is advantageous when an encircling peripheral region of the lower side of the planar element has no adhesive, or is not provided with adhesive, respectively. Along the edges of the planar element, which extend in the passage direction or direction of passage of the planar element below the adhesive application apparatus, this can preferably be achieved by correspondingly delimiting the dispensing opening. In order to avoid that adhesive is likewise not applied adjacent to the edges (i.e. the leading edge and the trailing edge) of the planar element, which extend transversely to the passage direction or direction of passage of the planar element, a preferably adjustable wiping element can be used. The wiping element is adjusted as required in such a manner that the adhesive applied to the lower side of the planar element, in the peripheral region of the edges of the planar element extending transversely to the passage direction or direction of passage, is wiped off again after application. Thus, it is possible to transport the tiles preferably seamlessly adjacent to each other below the adhesive application apparatus and still ensure that a peripheral region of the lower side of the planar element is adhesive-free. The peripheral region on the lower side, which preferably remains adhesive-free, proceeding from the respectively adjacent edge, can preferably have a depth of 5 mm to 20 mm, preferably 8 mm to 15 mm.

The adhesive can be wiped off the edges of the planar element in a particularly simple way by the adjustable wiping element, which can preferably assume a first position, in which the toothed spatula structure is released, and a second position, in which the toothed spatula structure is closed. The wiping element can be formed in the manner of a bulkhead and in the second position close the passage openings in the toothed spatula structure. The bulkhead can be moved up or down to assume the first (upper) position or the second (lower) position. The displacement travel of the bulkhead between the first and the second position can preferably be 3 mm to 30 mm, in particular 3 mm to 20 mm.

Additionally or alternatively to the fact that the adhesive after application is wiped off by a suitable positioning (second position) of the wiping element, it can also be provided to close the dispensing opening so that no adhesive, or a small amount of adhesive, is applied to the encircling peripheral region.

According to the invention, a storage station can also be provided, in which the planar element is or has been kept available as part of a pack of similar planar elements which are disposed stacked on top of one another conjointly in a packaging, wherein an unpacking station is provided, and the pack is or has been moved, preferably by means of a multi-axis robot, in particular a 6-axis robot, from the storage station to the unpacking station and placed on a support surface of the unpacking station, wherein the unpacking station is specified to remove the packaging, and wherein an onward transport apparatus, preferably a multi-axis robot, in particular a 6-axis robot, is provided to pick up the respectively uppermost planar element of the pack, and to place it on the support surface, preferably a conveyor belt, in such a manner that the lower side of the planar element is oriented upward.

It has proven to be particularly advantageous when the device according to the invention has a storage station in which the planar element is provided as part of a pack of similar planar elements which are disposed conjointly in a packaging. Additionally, but also independently of the storage station, an unpacking station can be provided, in which the planar element is placed as part of a pack of similar planar elements which are disposed conjointly in a packaging. The pack herein can preferably be removed from the storage station, but can also be made available elsewhere. The pack can preferably be placed on the unpacking station by means of a multi-axis robot, in particular a 6-axis robot. The unpacking station can preferably have a support surface or a platform for this purpose. The pack with the planar elements is preferably placed on the unpacking station, in particular a support surface or a platform of the unpacking station in such a manner that the lower sides of the planar elements of the pack are oriented upward.

The unpacking station can be set up to remove the packaging. For this purpose, the unpacking station can have a cutting apparatus. The cutting apparatus can comprise one or a plurality of cutting elements, in particular knives. The knives can preferably be formed in each case in such a manner that the cutting edge of the knives opens at an angle of 30 degrees to 90 degrees, preferably 40 degrees to 50 degrees. The cutting elements are preferably provided to cut the packaging of the pack in such a manner that the packaging can be removed. The cutting apparatus of the unpacking station is preferably designed to cut the packaging along the lower side of the pack up to one, a plurality of, or preferably all vertical corners/edges. For this purpose, a corresponding number of cutting elements, preferably four cutting elements, can be provided. The vertical corners/edges of the packaging extend orthogonally to the lower side or upper side of the planar elements.

It is advantageous when a further transport apparatus is provided as part of the device according to the invention in order to receive the respectively uppermost planar element of the pack after the packaging has been correspondingly cut or removed, and to place said element on the support surface in such a manner that the lower side of the planar element is oriented upward. In this orientation, the planar element can then be fed to the adhesive application apparatus, or the adhesive application apparatus can be offered up to the planar element. Preferably, the support surface is formed as a conveyor belt, so that it is preferably provided that the conveyor belt transports the resting planar element to the adhesive application apparatus.

The onward transport apparatus, which picks up in each case the uppermost planar element of a pack and transports it to the support surface, can preferably be a multi-axis robot, in particular a 6-axis robot. The onward transport apparatus can be specified to turn the uppermost planar element resting on the unpacking station in such a manner that the planar element can be placed on the support surface with the lower side oriented upward. Preferably, however, the planar elements of the pack are already oriented on the unpacking station in such a manner that the lower side of the planar element is oriented upward, so that turning the planar element by means of the onward transport apparatus is not necessary. This has proven to be advantageous. However, turning can be necessary if the planar elements are disposed in different orientations in the pack.

Preferably, the conveyor belt on which the multi-axis robot places the planar element, so that this can then be conveyed to the adhesive application apparatus, is designed as a belt conveyor, preferably with two spaced-apart belt units between which the distance is selected such that the head of the multi-axis robot, which places the planar element, can move away in the downward direction.

Hereunder, a particularly advantageous lifting-and-turning apparatus, in particular for use in the context of the method according to the invention and/or in the context of the device according to the invention is to be disclosed. However, the lifting-and-turning apparatus can also be advantageously used independently of the method according to the invention or device according to the invention. The lifting-and-turning apparatus is designed in such a manner that it is suitable to pick up a planar element, in particular a tile, which by way of the lower side is oriented upward and preferably rests on a support surface, to lift said planar element by a lifting movement and to turn it over in such a manner that the lower side of the planar element is oriented upward. The turning procedure can preferably be carried out simultaneously with the lifting movement.

The lifting-and-turning apparatus can preferably have a gripping apparatus with a plurality of gripping units or gripping hands in order to pick up the planar element. The gripping apparatus can preferably have a horizontally extending horizontal beam on which the gripping units or the gripping hands are formed, preferably in such a manner that the gripping apparatus has two gripping units or gripping hands which can engage on two opposite edges or lateral edges of the planar element and preferably move toward or away from one another, in order to pick up the planar element. The gripping units or gripping hands are preferably movable along a longitudinal axis of the horizontal beam relative to one another. The gripping units can be designed as clamping jaws.

The lifting-and-turning apparatus can preferably further have a lifting unit to lift the planar element. The lifting-and-turning apparatus can preferably have a vertically extending vertical beam, or a vertically extending tower. Preferably, the horizontal beam, which supports the gripping unit or the gripping hands, is movable in the longitudinal direction along the vertical beam, or the vertical tower, in the vertical direction by means of the lifting unit, meaning that the horizontal beam is movable at least along a partial distance between the upper and lower ends of the vertical beam or the vertical tower. Furthermore, the lifting-and-turning apparatus can preferably have a rotating unit to rotate the gripping apparatus or the horizontal beam by 180°, so that the originally upwardly oriented lower side of the planar element is oriented downward. The rotating unit can preferably be designed in such a manner that it is disposed on an end region of the horizontal beam and connected to it in such a manner that the rotating unit rotates the horizontal beam by 180°. The rotating unit can also be designed in such a manner that it can rotate the horizontal beam by 360°. The rotating unit can preferably be formed as a rotating ring or as a rolling bearing, in particular as a large-diameter rolling bearing, on which the horizontal beam is disposed. The rotating ring can preferably have a toothing on its outside and/or on its inside, in which a drive element, preferably a drive pinion engages so as to set the rotating ring in rotation and thereby rotate the gripping apparatus or the horizontal beam. The rotating unit is preferably connected to the lifting unit, so that the rotating unit can be moved in a vertical direction along the vertical beam, or can be lifted and lowered. The lifting apparatus can possess threaded rods and/or lifting cylinders for lifting and lowering the rotating unit.

The gripping apparatus can possess a clamping apparatus to clamp the gripping units or the gripping hands relative to one another.

The lifting-and-turning apparatus is preferably designed in such a manner that the planar element at a lower displacement position of the lifting-and-turning apparatus is oriented in such a manner that the lower side is oriented upward, and at an upper displacement position is oriented in such a manner that the lower side of the planar element is oriented downward by virtue of the rotating unit.

The lifting-and-turning apparatus, conjointly with a feeding apparatus which is preferably designed as a multi-axis robot, in particular as a 6-axis robot, can form a pick-up and placing apparatus. For this purpose, the feeding apparatus and the lifting-and-turning apparatus are positioned spatially relative to one another in such a manner that the feeding apparatus can pick up from the lifting-and-turning apparatus the planar element, the lower side thereof being oriented downward, move the latter to a concrete body, and press the lower side of the planar element onto the upper side of the concrete body. In this case, a concrete body provisioning apparatus can also be part of the pick-up and placing apparatus. The feeding apparatus picks up the planar element preferably from the lifting-and-turning apparatus from above, and then places the planar element on the concrete body from above.

It is also the intention to disclose an unpacking station which can be used in particular for use with the method according to the invention or the device according to the invention, but also independently thereof. The unpacking station is designed in such a manner that it is suitable to receive a pack of similar planar elements stacked on top of one another, in particular tiles, which are disposed conjointly in a packaging. The unpacking station can have a support surface or a platform on which the pack can be placed. The unpacking station can possess a cutting apparatus suitable for cutting open the packaging. The cutting apparatus can preferably be designed in such a manner as has already been disclosed in the context of the device according to the invention. The unpacking station cuts the packaging in particular in such a manner that the uppermost planar element of the pack is exposed.

The unpacking station can have a cutting apparatus, which preferably possesses one, in particular a plurality of, preferably four arms or linear units, which preferably extend in a star-shaped manner preferably below the support surface, or the platform, in a horizontal plane plane-parallel to the lower side of the pack, or of the planar elements, and which are suitable to receive in each case one cutting element which is able to be offered up along the lower side to a corner or edge of the packaging, or a corner or edge of the pack, in such a manner that the cutting element cuts the packaging on the lower side up to the corner or edge. It has been demonstrated that it is sufficient when the cutting elements cut the packaging only on the lower side, preferably in such a manner that the packaging is cut at the lower side by means of a corresponding number of cutting element toward all corners.

The unpacking station can preferably have a vertical column at the upper end of which the support surface or the platform is formed.

The multi-axis robots, if present, are preferably part of the device or the method, respectively.

It should be mentioned that both the unpacking station and the lifting-and-turning apparatus and the adhesive application apparatus each represent independent inventions, which can also be used independently of the method according to the invention or the device according to the invention. The lifting-and-turning apparatus, the unpacking station and the adhesive application apparatus can be defined accordingly by the respective claims 23, 24 and 25, preferably in conjunction with the further features which are mentioned in the context of the application pertaining to the respective apparatus or station and can be used in each case individually or in any combination with one another for the purpose of defining or designing the inventions.

An advantageous protection claim for the lifting-and-turning apparatus is that the lifting-and-turning apparatus is suitable to pick up in an automated manner a planar element, in particular a tile, resting on a support surface with the lower side facing upward, from the support surface, to lift said planar element by a lifting movement and to turn it over in such a manner that the lower side of the planar element is oriented downward.

An advantageous protection claim for the unpacking station is that the unpacking station is suitable to receive a pack of similar planar elements stacked on top of one another, in particular tiles, which are disposed conjointly in a packaging, wherein the planar element is part of the pack, and wherein the unpacking station is specified to cut open and remove in an automated manner the packaging in such a way that the uppermost planar element of the pack is exposed.

An advantageous protection claim for the adhesive application apparatus is that the adhesive application apparatus has an adhesive receptacle space and a dispensing opening, and is designed in such a manner that the planar element can be transported in an automated manner below the adhesive application apparatus to apply the adhesive from the dispensing opening during the transport of the planar element, preferably with a toothed spatula structure, to the upwardly oriented lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction.

The present invention also relates to a composite body having a concrete body and a planar element, wherein the composite body is produced according to a method as claimed in one of claims 1 to 13 and/or by a device as claimed in one of claims 14 to 22.

Features which have been described in connection with one of the subjects of the invention, specifically provided by the method according to the invention, the device according to the invention, the lifting-and-turning apparatus, the unpacking station or the adhesive application apparatus, are also advantageously implementable for the other subjects of the invention. Likewise, advantages specified in connection with one of the subjects of the invention can also be understood in relation to the other subjects of the invention. In addition, it should be noted that expressions such as “comprising”, “having” or “with” do not exclude any other features or steps. Furthermore, terms such as “a” or “the” that refer in singular to steps or features do not exclude a plurality of features or steps-and vice versa.

It should be noted that labels such as “first” or “second”, etc. are used predominantly for reasons of being able to distinguish between respective device or method features and are not necessarily intended to indicate that features require one another or are related to one another.

The invention will be described in more detail hereunder by means of the drawing and an exemplary embodiment.

The figures each show preferred exemplary embodiments in which individual features of the present invention are illustrated in combination with one another. Features of one exemplary embodiment can also be implemented separately from the other features of the same exemplary embodiment.

Elements of equivalent function are denoted by the same reference signs in the figures.

In the figures:

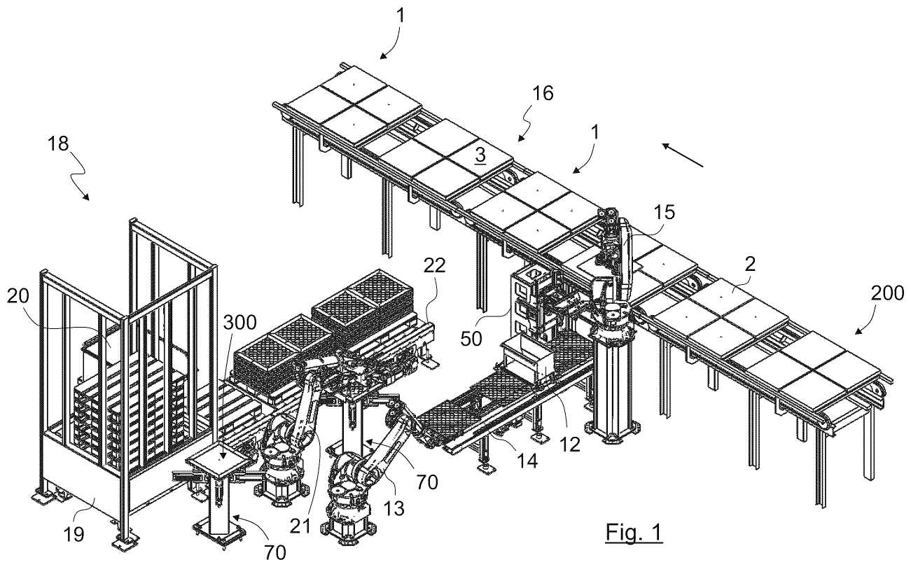

FIG. 1 shows a schematic illustration of a device according to the invention, or of a method according to the invention, for producing a composite body;

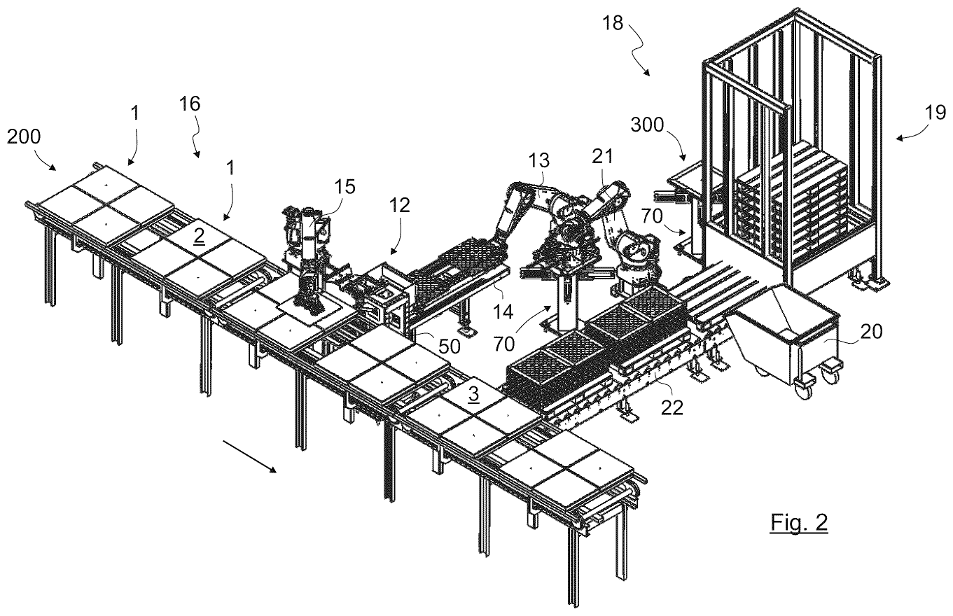

FIG. 2 shows a schematic illustration according to FIG. 1, from a second perspective;

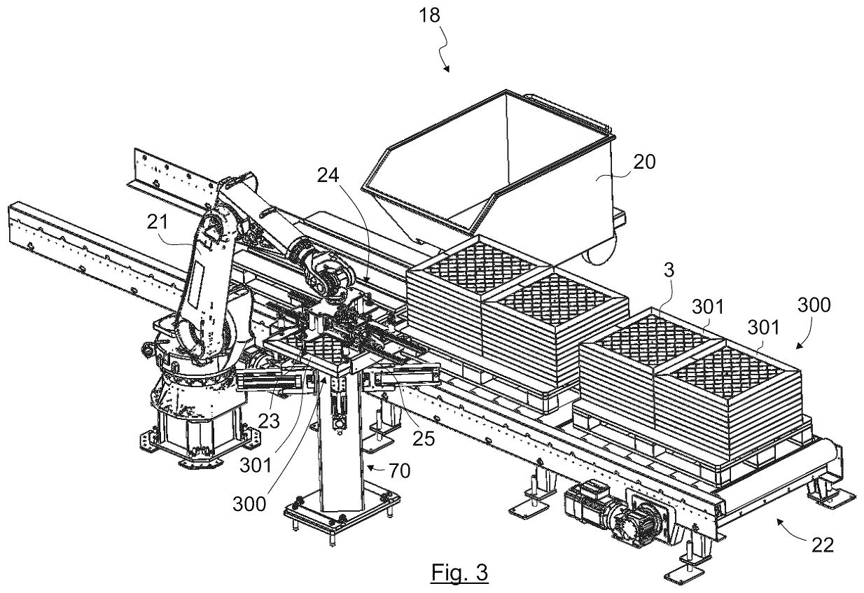

FIG. 3 shows a schematic illustration of part of the device according to the invention, or of the method according to the invention, with a storage station and an unpacking station;

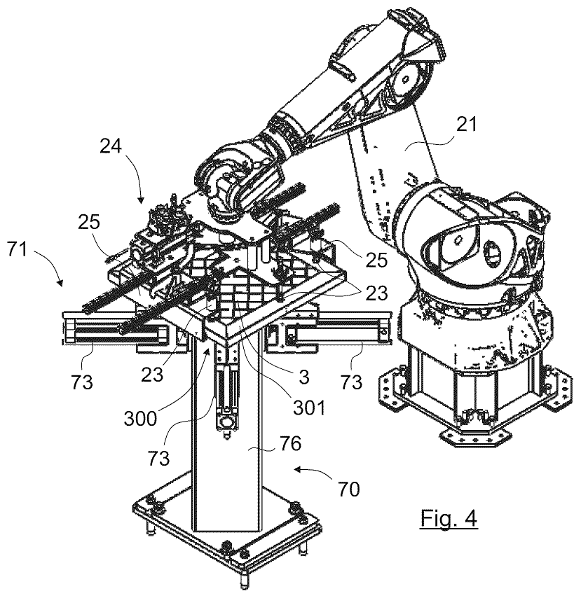

FIG. 4 shows a perspective illustration of an unpacking station and a third multi-axis robot;

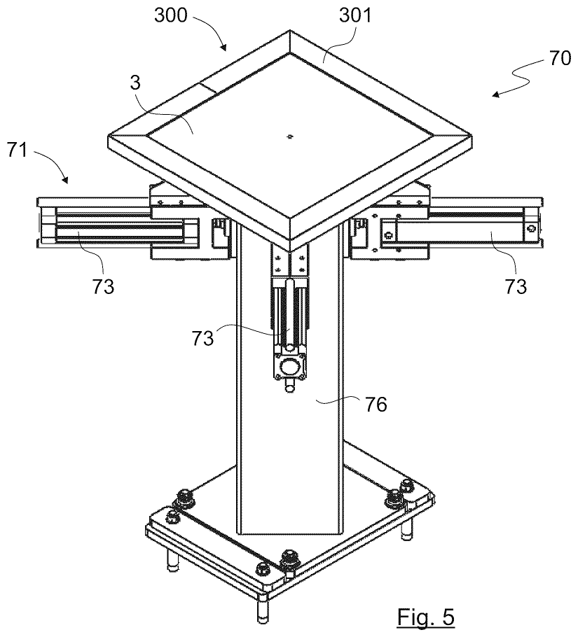

FIG. 5 shows a further perspective illustration of the unpacking station according to FIG. 4;

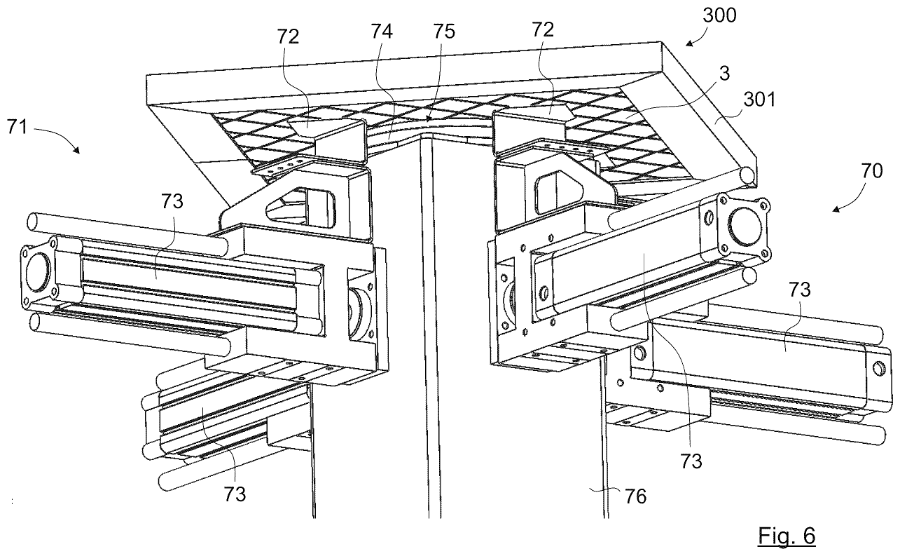

FIG. 6 shows a further perspective illustration of the unpacking station according to FIG. 4;

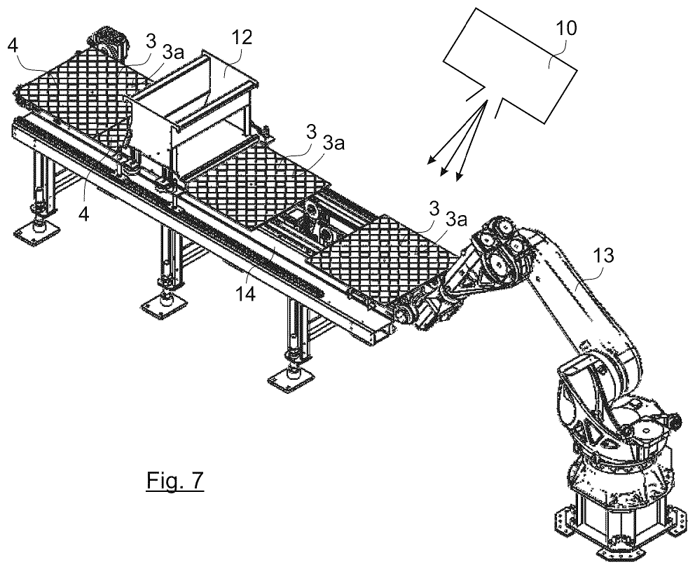

FIG. 7 shows a schematic illustration of part of the device according to the invention, or of the method according to the invention, for applying an adhesive to a lower side of a planar element, with an illustration of a first multi-axis robot to place the planar element on a support surface;

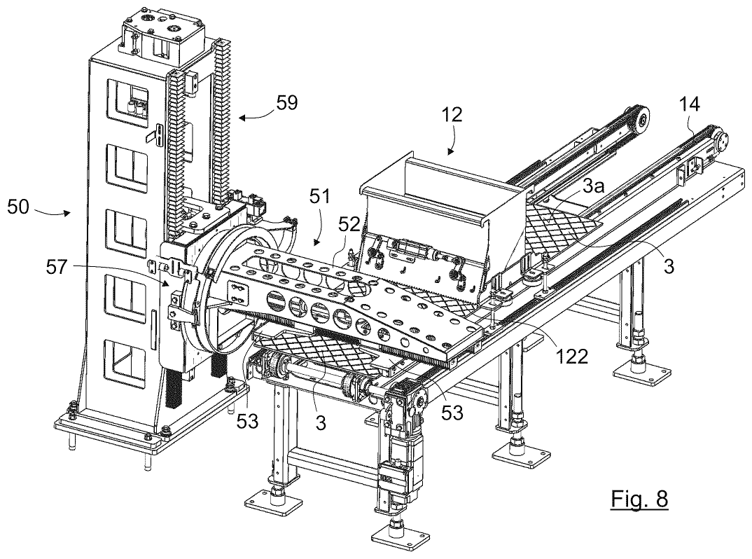

FIG. 8 shows an illustration according to FIG. 7, wherein instead of a first multi-axis robot for placing the planar elements, a lifting-and-turning apparatus for lifting a planar element from the support surface is shown, wherein a lifting unit of the lifting-and-turning apparatus is in a lower position;

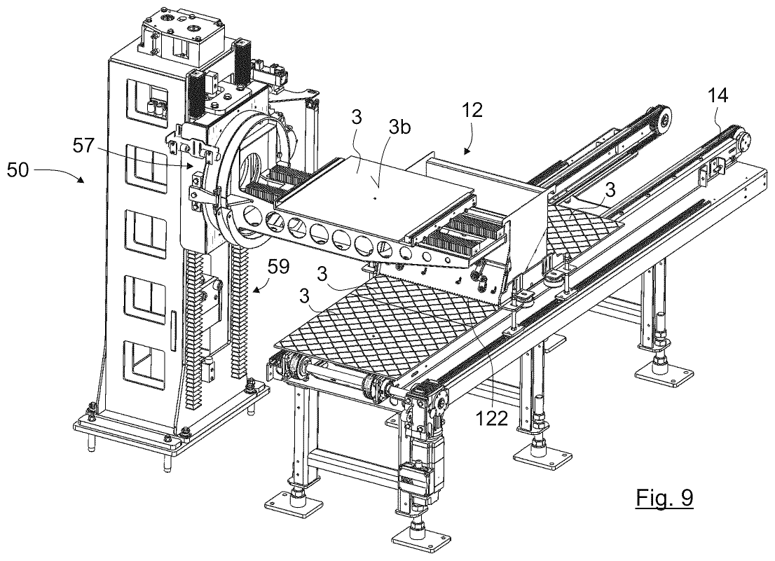

FIG. 9 shows an illustration according to FIG. 8, wherein the lifting unit is in an upper position;

FIG. 10 shows a perspective illustration of the lifting-and-turning apparatus according to FIG. 8;

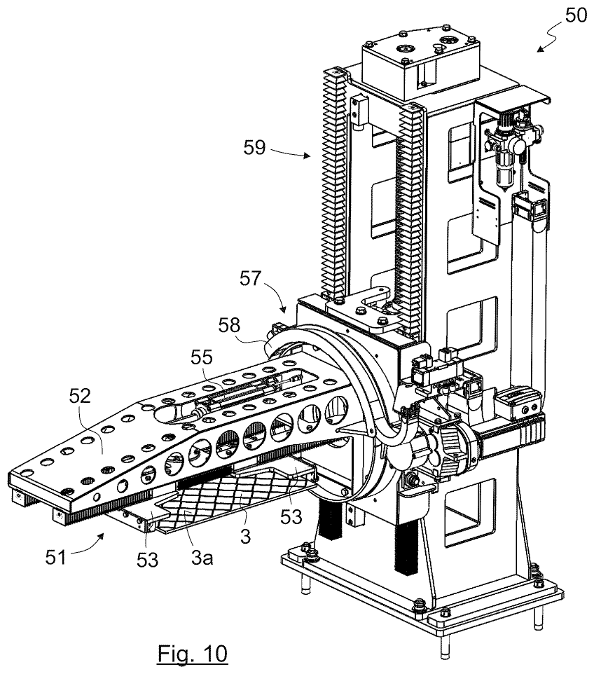

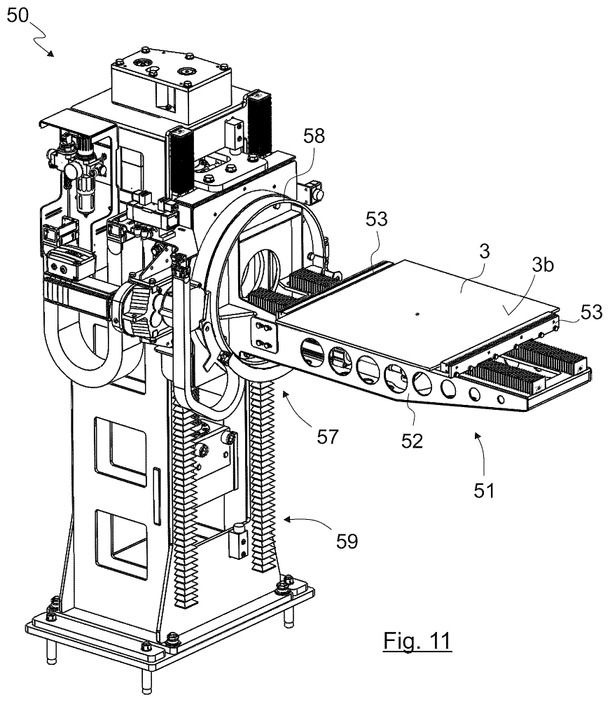

FIG. 11 shows a perspective illustration of the lifting-and-turning apparatus according to FIG. 9;

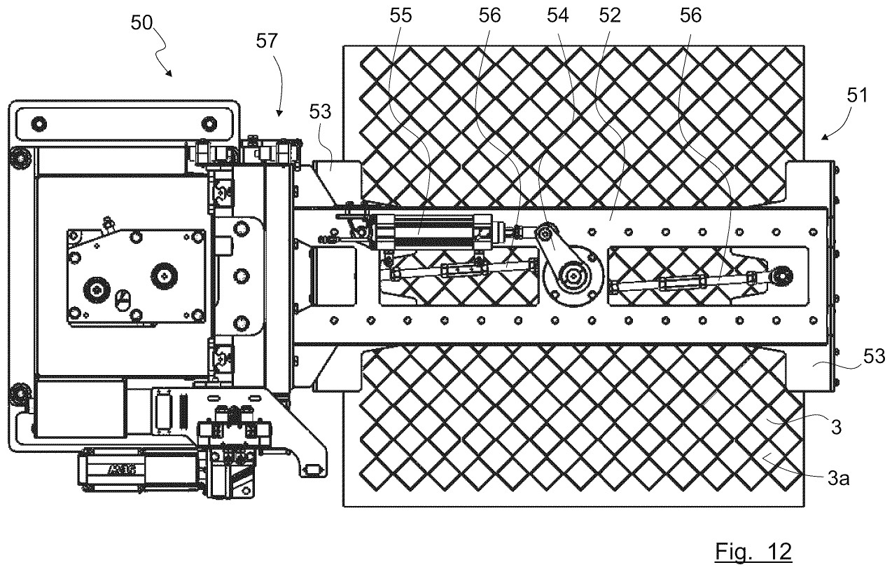

FIG. 12 shows a plan view from above of the lifting-and-turning apparatus according to FIG. 8;

FIG. 13 shows a schematic illustration of part of the device according to the invention, or of the method according to the invention, to press a planar element onto a concrete body, with an illustration of a lifting-and-turning unit;

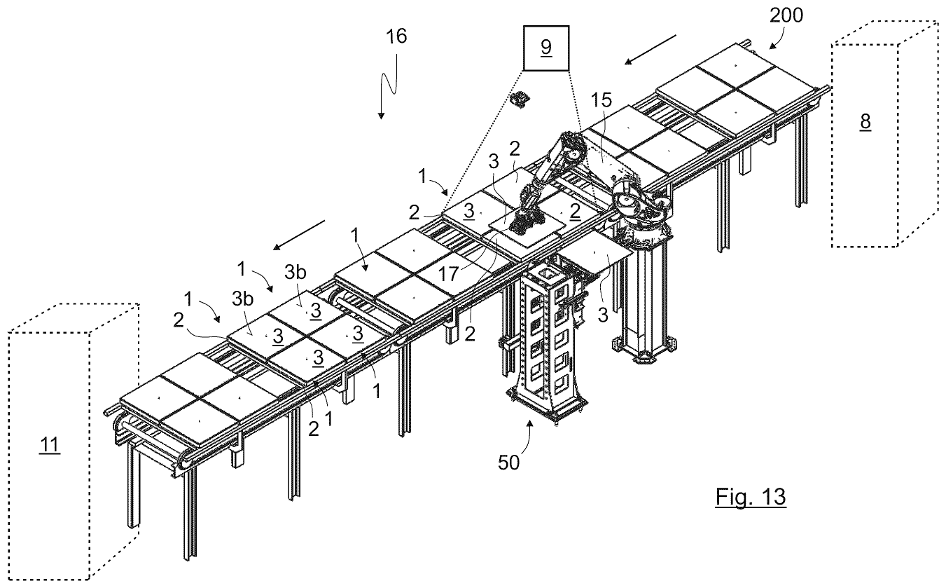

FIG. 14 shows a perspective illustration of an adhesive application apparatus;

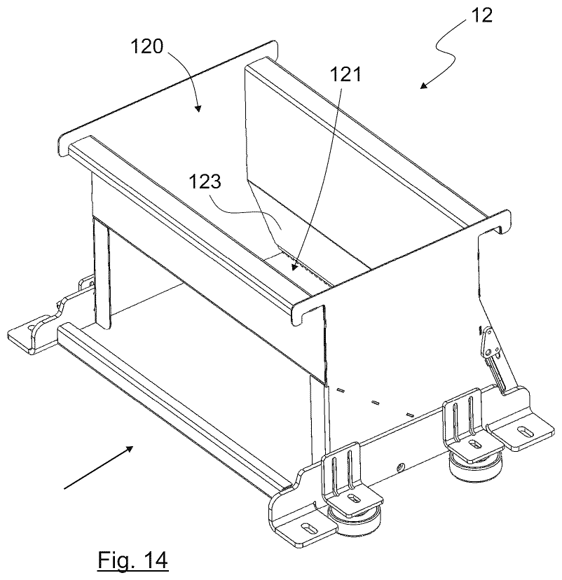

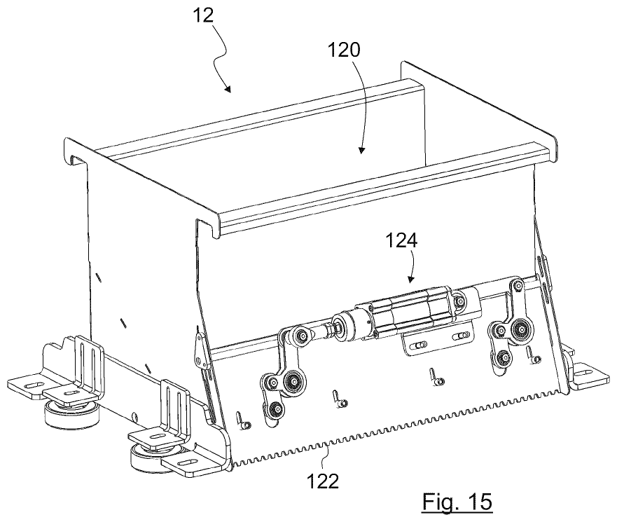

FIG. 15 shows a further perspective illustration of an adhesive application apparatus according to FIG. 14;

FIG. 16 shows a detailed illustration of a front side of the adhesive application apparatus having a wiping element in an upper, open first position;

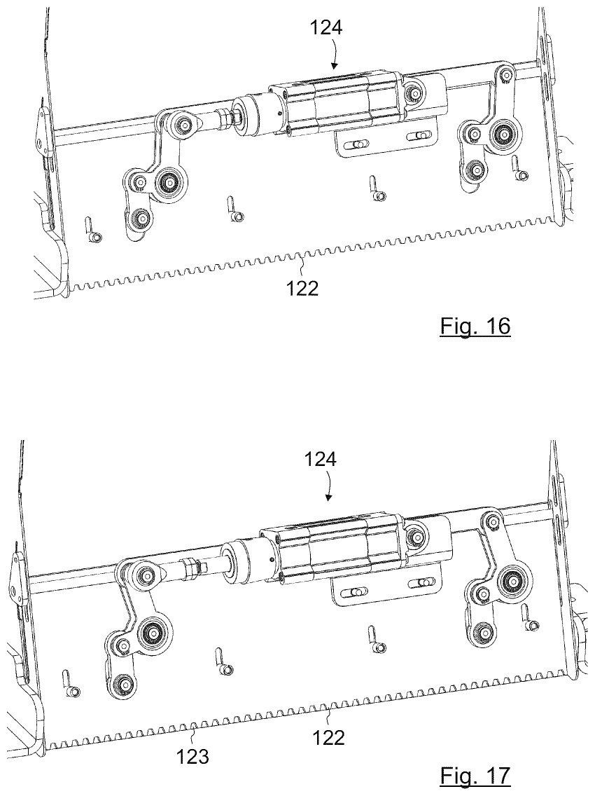

FIG. 17 shows a detailed illustration of a front side of the adhesive application apparatus having a wiping element in a lower, closed second position;

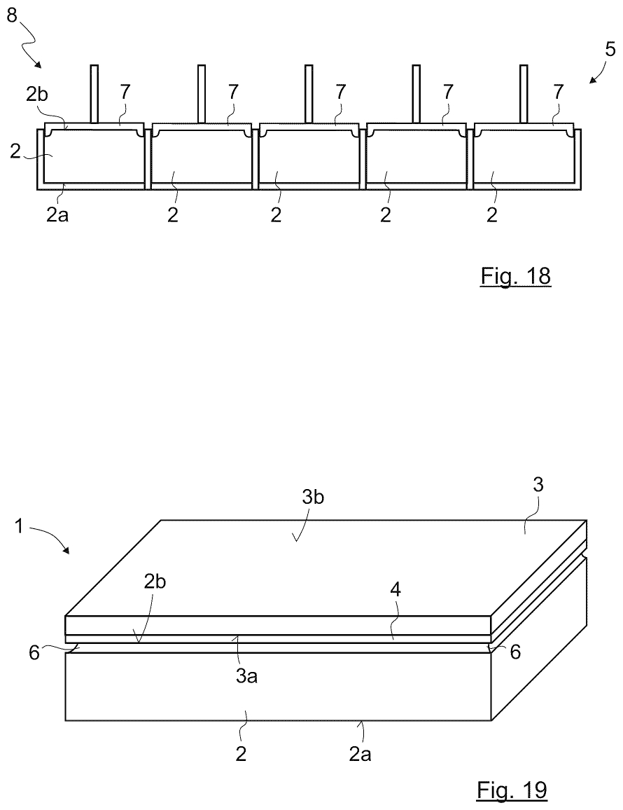

FIG. 18 shows a schematic cross section of a production mold with an exemplary illustration of five casting molds in which a concrete body is or has been formed in each case, and with an illustration of punches pressing from above onto the concrete body in order to compact it and, if necessary, structure it or chamfer it; and

FIG. 19 shows a schematic illustration of a composite body which comprises a concrete body and a planar element, wherein the lower side of the planar element is adhesively bonded to a lower side of the concrete body and an upper side of the planar element forms an upper side of the concrete body.

The following exemplary embodiment is used for the disclosure of an advantageous method for producing a composite body and for the disclosure of an advantageous device for producing a composite body. A composite body 1 produced according to the method or by means of the device is schematically illustrated in FIG. 19.

The following exemplary embodiment also serves for the disclosure of a lifting-and-turning apparatus, an adhesive application apparatus and an unpacking station, which are in each case preferably provided for use in a method or a device for producing a composite body, but which can also be used independently thereof. The lifting-and-turning apparatus can be used for lifting and turning a planar element, in particular a tile or a ceramic. The unpacking station can be generally used to receive a pack of similar planar elements, in particular tiles or ceramics, which are disposed conjointly in a packaging, to cut open the packaging and remove it so that the uppermost planar element of the pack is exposed. The adhesive application apparatus can generally serve to apply in an automated manner adhesive to a lower side of a planar element, in particular a tile or ceramic.

The composite body 1 has a concrete body 2 and a planar element 3.

The concrete body 2 has a lower side 2a and an upper side 2b.

The planar element 3 has a lower side 3a and an upper side 3b.

The lower side 3a of the planar element 3 is or has been adhesively bonded to the upper side 2b of the concrete body 2 in order to form the composite body.

As illustrated in FIG. 19, the upper side 3b of the planar element 3 forms an upper side of the composite body 1.

In the exemplary embodiment it is provided that an adhesive 4 is applied to at least a sub-region of the lower side 3a of the planar element 3. The adhesive 4 is illustrated (enlarged) in the schematic illustration in FIG. 19. The application of the adhesive 4 to the planar element 3 is shown, for example, in FIG. 7. In the exemplary embodiment, it is provided that the adhesive 4 is a mineral adhesive.

In a manner not illustrated in more detail, it is provided in the exemplary embodiment that the adhesive 4, preferably while omitting an encircling periphery, is applied to the lower side 3a of the planar element 3 in portions, optionally completely.

It can also be provided that the adhesive 4 is applied with a toothed spatula structure to the lower side 3a of the planar element 3, wherein the adhesive 4 is preferably applied in such a manner that the adhesive 4 in those regions in which the latter has a greater thickness on the lower side 3a of the planar element 3 has a thickness of 3 mm to 10 mm, preferably 4 mm to 8 mm, in particular 5 mm to 7 mm.

Furthermore, it can be provided in the exemplary embodiment that the upper side 2b of the concrete body 2 is structured, in particular roughened, and/or provided with grooves and/or with ribs and/or with a toothed spatula structure, before pressing the planar element 3. In the exemplary embodiment, potential structuring of the upper side 2b of the concrete body 2 is not illustrated in more detail. Structuring the upper side 2b of the concrete body 2 can be achieved particularly advantageously by a punch 7 described in more detail below and illustrated by way of example in FIG. 18. In the exemplary embodiment, it can furthermore be provided that the peripheral region of the upper side 2b of the concrete body 2, preferably encircling the upper side 2b of the concrete body 2, is provided with pockets and/or depressions and/or indentations and/or a chamfer 6, which are or is suitable to absorb adhesive 4 that has been displaced by pressing the planar element 3. In the exemplary embodiment, a circumferential chamfer 6 is shown by way of example in FIG. 19, which can serve as a reservoir for absorbing a displaced adhesive 4.

In the exemplary embodiment, it can be provided that a lower side of a punch 7 is designed in such a manner that the punch 7 provides the upper side 2b of the concrete body 2 with a chamfer 6, or incorporates a chamfer 6 into the upper side 2b of the concrete body 2. The punch 7 can alternatively or additionally also be designed in such a manner that it structures, in particular roughens, the upper side 2b of the concrete body 2, and/or incorporates pockets and/or depressions and/or indentations into the peripheral region of the upper side 2b of the concrete body 2.

The punch 7 can preferably be a punch 7 which is used for compacting the concrete body in a concrete body production apparatus 8.

A punch 7 of a concrete body manufacturing apparatus 8 is shown by way of example in FIG. 18. FIG. 18 shows that the punch 7 compacts the concrete body 2 or a concrete material located in a production mold 5. The number of casting molds that the production mold 5 has can be arbitrary. The production mold 5 can also have only one casting mold. The production mold 5 is of a preferably rectangular, in particular square, construction and preferably has both in the longitudinal direction and in the width direction a plurality of casting molds, e.g. an arrangement of 2×2, 2×3, 2×4, 2×5, 3×3, 3×4, 3×5, 4×4, 4×5, 5×5 casting molds.

The basic construction of a concrete body production apparatus 8 is sufficiently known. Illustrated in FIG. 18 is only a fragment of the concrete body production apparatus 8, which shows the production mold 5 with the individual casting molds and the punches 7. The concrete body production apparatus 8 is also shown in dashed lines and by way of example in FIG. 13.

In the production of the concrete bodies 2 or a concrete block, fresh concrete from cement, rock granules and water is generally poured into the individual casting molds of the production mold. The casting molds or the production mold 5 usually consist of metal or plastics material. In the casting molds, the freshly cast concrete solidifies and is compacted with the aid of one of the punches 7. Subsequently, the dimensionally stable, but not yet cured concrete body 2 from the production mold 5 or the casting mold is demolded and fed to the concrete body provisioning apparatus 16 (see FIGS. 1, 2 and 13) shown in more detail below.

In the exemplary embodiment, it is provided that the position of the concrete body 2 is determined, preferably measured, before pressing the planar element 3. In the exemplary embodiment, it is preferably provided for this purpose that the position of an entire production layer 200 of concrete bodies 2 is measured, preferably in that two diagonally opposite corner points of the production layer 200 are measured. FIGS. 1, 2 and 13 illustrate by way of example a plurality of production layers 200 of concrete bodies 2. Each production layer 200 is illustrated by way of example by four concrete bodies 2, which are positioned in a 2×2 arrangement.

For measuring purposes, a measuring apparatus 9 is shown in FIG. 13 by way of example in order to determine, in particular measure, the position of the concrete body 2 or a production layer 200. The measuring apparatus 9 is preferably an optical measuring apparatus. It is illustrated by dashed lines in FIG. 13 that the measuring apparatus 9 measures two diagonally opposite corners of the production layer 200.

In the exemplary embodiment, it is preferably provided that the lower side 3a of the planar element 3 is cleaned of dust before applying the adhesive 4. By way of example, a cleaning apparatus 10 is shown in FIG. 7, which can be designed in such a manner that it cleans the lower side 3a of the planar element 3 before applying the adhesive 4. The cleaning apparatus 10 is preferably designed as a blower in the exemplary embodiment. The cleaning apparatus 10 can alternatively also be designed as a brushing tool. Alternatively or additionally, the cleaning apparatus 10 can also be provided to clean, in particular to blow off or brush off dust from, the upper side 2b of the concrete body 2 before pressing the planar element 3. The cleaning apparatus 10 can optionally have two or a plurality of, preferably independently operable cleaning modules for this purpose.

In the exemplary embodiment, it is provided that after adhesively bonding the planar element 3, the concrete body 2, i.e. the composite body 1 created as a result, is fed to a curing area, preferably a curing chamber 11. In the curing chamber 11 a higher temperature prevails, so that the concrete body 2 can cure or set. The curing chamber 11 also facilitates the curing of the adhesive 4. A curing chamber 11 is illustrated in dashed lines and by way of example in FIG. 13.

In the exemplary embodiment, it is preferably provided that the dimensions of the lower side 3a of the planar element 3 correspond substantially to the dimensions of the upper side 2b of the concrete body 2. The planar element 3 can preferably have a size of at least 10 cm×10 cm and preferably of at most 120 cm×120 cm, wherein the planar element 3 in the plan view does not have to be square, but can also have rectangular shapes or other polygonal shapes; round or oval shapes are optionally possible too.

The shape of the concrete body 2 and of the composite body formed by the adhesive bonding is designed accordingly. The extent of the lower side 3a of the planar element 3 in a longitudinal direction and a width direction is preferably in each case 1 mm to 40 mm, preferably 2 mm to 30 mm, in particular 3 mm to 20 mm, particularly preferably 4 mm to 10 mm smaller than an extent of the upper side 2b of the concrete body 2 in the respective direction.

In the exemplary embodiment, a particularly preferred method step for adhesively bonding the planar element 3 to the concrete body 2 is shown in FIGS. 1, 2 and 13. It is provided that the planar element 3, after the concrete body 2 has left the production mold 5 in which the concrete body 2 is compacted, is adhesively bonded to the concrete body 2.

Alternatively, in a manner not shown in detail, it can also be provided that the planar element 3 is adhesively bonded to the concrete body 2, while the concrete body 2 is still in the production mold 5, which is illustrated by way of example in FIG. 15. The adhesive bonding of the planar element 3 to a concrete body 2, which is still in the production mold 5, is preferably carried out in a state of the concrete body 2 in which the latter is green-stable. In principle however, it would also be possible, for special design embodiments, that the planar element 3 is pressed, in particular while vibrating, onto a concrete material which is located in the production mold 5, before a green-stable concrete body 2 is formed from the concrete material.

The planar element 3 shown in the exemplary embodiment is preferably a slab, in particular a ceramic slab or a tile. However, the planar element 3 can also be another slab, for example also a rubber slab, a vinyl slab, a checker board, a stainless steel slab or a metal slab, in particular having a structured upper side. The planar element 3 can alternatively also be formed as natural stone or as a laminate.

As derived from FIGS. 1, 2, 7 to 9 and 14 to 17, an adhesive application apparatus 12 is provided in the exemplary embodiment, which is specified to apply an adhesive 4 to at least a sub-region of the lower side 3a of the planar element 3.

It is illustrated by way of example in FIGS. 1, 2 and 7 that the planar element 3 is preferably placed on a support surface, preferably a conveyor belt 14, preferably with the aid of an onward transport apparatus 13, in particular a first multi-axis robot 13, preferably a 6-axis robot. In the process, the planar element 3 is placed in such a manner that the lower side 3a of the planar element 3 is oriented upward. With the aid of the optional cleaning apparatus 10, the lower side 3a of the planar element 3 can be blown off. The conveyor belt 14 in the exemplary embodiment according to FIGS. 1, 2 and 7 is specified in such a manner that it transports the placed planar elements 3 below the adhesive application apparatus 12. During transport, the adhesive 4 is preferably applied by the adhesive application apparatus 12 with a toothed spatula structure, preferably as described above and below.

For applying the adhesive 4 to the lower side 3a of the planar element 3, the support surface or the conveyor belt 14 and the adhesive application apparatus 12 are preferably designed in such a manner that the planar element 3 is transported, preferably in an automated manner, below the adhesive application apparatus 12, and the adhesive 4 is applied to the upwardly oriented lower side 3a of the planar element 3. The planar elements 3 are preferably transported seamlessly adjacent to one another below the adhesive application apparatus 12.

It should be mentioned that the application of the adhesive 4 can also be carried out with a differently designed adhesive application apparatus 12, for example by spraying or spreading, in particular in any orientation of the planar element 3.

In the exemplary embodiment, in place of a conveyor belt 14, another transport apparatus or support surface can further also be provided. The conveyor belt 14 is preferably designed in such a manner that the first multi-axis robot 13 can place the planar element 3 and move away in the downward direction. Preferably, the conveyor belt 14 is formed as a belt conveyor, in particular with two spaced-apart belt units between which the distance is selected in such a manner that a head of the multi-axis robot 13, which places the planar element 3, can move away in the downward direction.

In the exemplary embodiment, it is provided that the planar element 3 is disposed on the support surface or the conveyor belt 14 in such a manner that the lower side 3a of the planar element 3 is oriented upward for applying the adhesive 4. The adhesive 4 is then applied in an automated manner to at least a sub-region of the lower side 3a of the planar element 3 and the planar element 3 is then lifted in an automated manner from the support surface or the conveyor belt 14 and turned over in such a way that the lower side 3a of the planar element 3 is oriented downward.

A particularly advantageous embodiment of the adhesive application apparatus 12 will be described hereunder, in particular with reference to FIGS. 7 to 9 and FIGS. 14 to 17, which also represents an independent invention for applying adhesive 4 to the lower side 3a of a planar element 3, in particular a tile. The adhesive application apparatus 12 is particularly advantageously suitable for the device according to the invention and the method according to the invention.

The adhesive application apparatus 12 has an adhesive receptacle space 120, which is provided for receiving the adhesive 4. Furthermore, the adhesive application apparatus 12 has a dispensing opening 121 or a dispensing slot on the base of the adhesive receptacle space 120. The dispensing opening 121 preferably has an extent in the width direction which corresponds to the width of the planar element 3 to be conveyed, but is particularly preferably 10 mm to 50 mm smaller, so that in the peripheral region of the lower side of the planar element 3 or in the peripheral region of the two lateral edges (in the longitudinal direction of the feed direction) no adhesive is applied and a respective peripheral region of 5 mm to 25 mm remains adhesive-free in each case.

The adhesive application apparatus 12 preferably has at the front a toothed spatula structure 122 in the direction of passage of the planar elements 3. The toothed spatula structure 122 is preferably formed in a metal sheet which is preferably adjustable in height.

The inventors have recognized that it is advantageous when the planar element 3 is not completely provided with the adhesive 4 on the lower side 3a, but an encircling peripheral region remains free. The peripheral region of the planar element 3, which extends laterally in the feed direction of the planar element 3 on the conveyor belt 14, can preferably remain free in that the dispensing opening 121 has a smaller extent in the width direction, i.e. transversely to the feed direction, than the planar element 3. So that a peripheral region on the lower side 3a remains free even in the feed direction of the planar element 3 at the peripheral region adjacent to the front edge or the rear edge, it has proven to be advantageous when a closing element and/or a wiping element 123 is provided, which wipes off the adhesive 4 applied by means of the dispensing opening 121 from the lower side 3a of the planar element 3 again. In the exemplary embodiment, this is preferably achieved in that a wiping element, designed as a metal wiping sheet 123, is displaceable downward in the direction toward the lower side 3a of the planar element 3, or in the direction toward the conveyor apparatus 14 plane-parallel to the metal sheet in which the toothed spatula structure 122 is incorporated. The metal wiping sheet 123 is preferably displaced so far that the toothed spatula structure 122, or the passage openings of the toothed spatula structure 122, is or are completely closed. For this purpose, a locking mechanism 124 can be provided, which is shown in a preferred embodiment in FIGS. 16 and 17, and which possesses a linear unit, preferably a linear cylinder, which acts on the metal wiping sheet 123 by means of preferably two lever apparatuses and moves it plane-parallel to the metal sheet in which the toothed spatula structure 122 is incorporated.

Preferably, the wiping element 123 is adjusted so far downward that the adhesive 4 is completely or al-most completely wiped from the lower side 3a of the planar element 3. FIG. 16 shows an upper, open first position of the wiping element 123, and FIG. 17 shows a lower, closed second position of the wiping element 123.

For the automated lifting of the planar element 3 from the support surface or the conveyor belt 14, a lifting-and-turning apparatus 50 is preferably provided in the exemplary embodiment, for which reference is made to FIGS. 1, 2 and 8 to 13.

The lifting-and-turning apparatus 50 is particularly advantageously suitable for using the method according to the invention or the device according to the invention for producing a composite body 1, but can also be used independently thereof to lift and turn a planar element in an automated manner, preferably from a support surface or a conveyor belt, in such a manner that the originally upwardly oriented side of the planar element, in particular a lower side of the planar element, is oriented downward after lifting and turning.

Advantageous design embodiments and features of the lifting-and-turning apparatus 50 are illustrated in more detail below, in particular with reference to FIGS. 8 to 13.

After lifting and turning the planar element 3, preferably by means of the lifting-and-turning apparatus 50, the planar element 3 is moved to the concrete body 2 and pressed from above onto the upper side 2b of the concrete body 2 in an orientation in which the lower side of the planar element 3 is oriented downward. For this purpose, reference is made in particular to the illustration in FIGS. 1, 2 and 13.

In the exemplary embodiment, it is provided that the pressing of the planar element 3 on the concrete body 2 is preferably carried out in a green-stable state of the concrete body 2, in which the concrete body 2 is dimensionally stable, but not yet cured.

In the exemplary embodiment, it is provided in FIGS. 1, 2 and 13 that a feeding apparatus 15 picks up the planar element 3 provided with the adhesive 4, after the adhesive 4 has been applied to the lower side 3a of the planar element 3. In the exemplary embodiment, this takes place after the lifting-and-turning apparatus 50 has lifted and turned the planar element 3. Alternatively however, picking-up can also take place directly after the adhesive application apparatus 12, or directly from the conveyor belt 14 or any other transport apparatus.

The feeding apparatus 15 is designed in the exemplary embodiment as a second multi-axis robot. It should be noted that the use of the term “second multi-axis robot” does not mean that a first multi-axis robot must be provided. In the exemplary embodiment, the second multi-axis robot is preferably designed as a 6-axis robot.

The feeding apparatus 15 moves the planar element 3 to the concrete body 2 and presses the lower side 3a of the planar element 3 onto the upper side 2b of the concrete body 2. In the process, the concrete body 2 is located on a concrete body provisioning apparatus 16, as illustrated in FIGS. 1, 2 and 13. The concrete body provisioning apparatus 16 is designed in the exemplary embodiment as a transport apparatus, for example as a conveyor belt or conveyor table. The concrete bodies 2 are transported on the concrete body provisioning apparatus 16 from a concrete body production apparatus 8 in the direction of the curing chamber 11 (see direction of arrow in FIG. 13). The concrete body production apparatus 8 and the curing chamber 11 are shown in this case only by way of example and with dashed lines and can be positioned in particular so as to be significantly spaced apart from one another in spatial terms.

Located in the concrete body provisioning apparatus 16 are concrete bodies 2 which preferably display a green-stable state, i.e. are dimensionally stable, but are not yet cured. The feeding apparatus 15 is positioned relative to the concrete body provisioning apparatus 16 in such a manner that the planar element 3 is picked up by the lifting-and-turning apparatus 50, or optionally also immediately after the application of the adhesive 4, and can be pressed onto the green-stable concrete body 2 by means of the feeding apparatus 15 in one operational step.

In the exemplary embodiment, an activation apparatus 17 is provided, which moves, preferably vibrates and/or oscillates, the planar element 3 relative to the upper side 2b during pressing onto the concrete body 2, preferably plane-parallel and/or orthogonal to the upper side 2b, of the concrete body 2, in order to activate the adhesive 4. In the exemplary embodiment, the activation apparatus 17 is preferably formed as part of the feeding apparatus 15, for example as the head of the multi-axis robot. The movement of the planar element 3 during the pressing onto the concrete body 2 can also be generated directly by the mobility inherent to a multi-axis robot.

The activation apparatus 17 can preferably be designed as a vibration and/or oscillation unit.

The pressing of the planar element 3 onto the concrete body 2 is schematically illustrated in FIGS. 1, 2 and 13. The concrete body 2 is preferably in a green-stable state when the planar element 3 is pressed thereon, i.e., pressing the planar element 3 onto the concrete body 2 is preferably carried out in a green-stable state of the concrete body 2, in which the concrete body 2 is dimensionally stable, but not yet cured.

FIGS. 1 and 2 show advantageous aspects of the method according to the invention and the device according to the invention from two different angles of view.

Also illustrated here is a storage station 18 in which the planar elements 3 are or have been made available as part of a pack 300 of similar planar elements 3 which are disposed conjointly in a packaging 301. Part of the storage station 18 can also be a pallet station 19, in which the pallets with which the packs 300 were transported are taken. Also illustrated by way of example is furthermore a collection station, for example a transport cart 20, which can be part of the storage station 18 and which can be provided in particular to receive the packaging 301 after the unpacking of the pack 300.

As illustrated in FIGS. 1, 2 and 3, and in detail in FIGS. 4 to 6, the device according to the invention and the method according to the invention can also comprise one, preferably a plurality of, in particular two unpacking stations 70.

A pack 300 from the storage station 18 (or else from any other station) can be placed on the unpacking station 70, preferably by means of a multi-axis robot, which is referred to in the exemplary embodiment as the third multi-axis robot 21. However, placing a pack 300 can also be performed otherwise, preferably in an automated manner, but optionally also manually.

The storage station 18 preferably has a conveyor apparatus 22 which is suitable to accommodate a plurality of pallets on which a plurality of packs 300 of planar elements 3 are stacked in each case. In the exemplary embodiment, it is shown by way of example that there are two stacks of packs 300 on each pallet.

The conveyor apparatus 22 preferably has a support region on which a pallet with the stacks of packs 300 is placed, for example with the aid of a forklift truck. The conveyor apparatus 22 preferably has an operating region in which a pallet with one or a plurality of stacks of packs 300 is located. It is provided here that the third multi-axis robot 21 removes in each case a pack 300 from the stacks of packs 300, which are located in the operating region on the conveyor apparatus 22, and places it on one of the unpacking stations 70. The conveyor apparatus 200 furthermore preferably has a discharge region in which a third pallet, from which the stacks of packs 300 have already been removed, is located. From this region, the pallet can then be moved manually, but preferably automatically, to the pallet station 19. The pallet is preferably introduced into the pallet station 19 in such a way that it is fed to the stack of pallets already located there from below.

The preferably provided construction of the storage station 18 is shown in FIGS. 1 to 3. Also illustrated is the transport cart 20 which is used to receive the packaging 301 of the packs 300. The filling of the transport cart 20 can be carried out by the third multi-axis robot 21.

As can be seen from FIGS. 1 and 2, the device according to the invention or the method according to the invention in the exemplary embodiment preferably has two unpacking stations 70. Furthermore, precisely a third multi-axis robot 21 is preferably provided to place a pack 300 on each of the unpacking stations 70. Furthermore, precisely a first multi-axis robot 13 is preferably provided to remove in each case the uppermost planar element 3 from an unpacking station 70 when the packaging 301 has been removed from the pack 300.

It is particularly advantageous when the third multi-axis robot 21 places a pack 300 on an unpacking station 70 and, after cutting the packaging by the unpacking station 70, removes the packaging 301 and moves into the transport cart 20, while the first multi-axis robot 13 removes from the other unpacking station 70, on which a pack 300 is located from which the packaging 301 is already removed, in each case the uppermost planar element 3 of the pack 300 and places it on the conveyor belt 14, or the support surface. This allows the cycle times to be optimized.

The multi-axis robots 13, 15, 21 can possess suitable gripping apparatuses, preferably having in each case two gripping elements or clamping jaws which are able to be clamped relative to one another in order to pick up the pack 300 or the planar element 3. Alternatively or additionally, the gripping apparatuses can also be designed as a suction apparatus, in particular with a vacuum apparatus, with the aid of which the planar elements 3 are suctioned and lifted.

For receiving the planar element 3 from the unpacking station 70, it has proven to be particularly advantageous when the first multi-axis robot 13 possesses a suction apparatus, with the aid of which the planar element 3 can be suctioned.

The unpacking station 70 is designed to remove the packaging 301 from the pack 300. For this purpose, the unpacking station 70 is designed in such a manner that the packaging 301 can be cut open in the unpacking station 70 and removed so that the respectively uppermost planar element 3 of the pack 300 can be removed. The uppermost planar element 3 of the pack 300 is removed from the unpacking station 70 and placed on the support surface or the conveyor belt 14 in such a manner that the lower side 3a of the planar element 3 is oriented upward.

In the exemplary embodiment, the first multi-axis robot 13 is used for removing the respectively upper-most planar element 3 of the pack 300. Instead of a multi-axis robot 13, any other onward transport apparatus can also be provided to receive the respectively uppermost planar element 3 of the pack 300.

Placing the planar element 3 of the pack 300 on the support surface or the conveyor belt 14 in such a manner that the lower side 3a of the planar element 3 is oriented upward, can take place in that the onward transport apparatus or the multi-axis robot rotates, or turns over, the planar element 3 accordingly after it has been received by the unpacking station 70. However, it is preferable that the pack 300 with the planar element 3 is already placed on the unpacking station 70 in such a manner that the lower side 3a of the planar element 3 is oriented upward, so that the onward transport apparatus or the multi-axis robot 13 can place the planar element in this orientation on the support surface or the conveyor belt 14. The pack 300, which the multi-axis robot 21 places on the unpacking station 70, typically comprises two to ten, in particular two to four, planar elements 3. The number of planar elements 3 of a pack 300 is not limited. In most cases, the planar elements 3 of a pack 300 are not disposed in a uniform orientation in the tile pack, but in such a manner that in part of the planar elements 3 the upper side 3b is oriented upward and in another part of the planar elements 3 the lower side 3a is oriented upward. The first multi-axis robot 13 is therefore preferably designed in such a manner that it can turn over the planar element 3, if necessary, by 180°, so that the planar element 3 can be placed on the conveyor belt 14 or the support surface in such a manner that the lower side 3a of the planar element 3 is oriented upward.

A particularly advantageous construction of the unpacking station 70 is shown in FIGS. 4 to 6.

The unpacking station 70 has a cutting apparatus 71 which is suitable for cutting the packaging 301. The cutting apparatus 71 is designed to cut the packaging 301 on the lower side of the pack 300. In the exemplary embodiment, the cutting apparatus 71 preferably has two, in particular four, cutting tools 72, preferably knives, which cut the packaging 300 on the lower side of the pack 300, in each case in the region of the corners or the vertically extending edges. Shown in FIG. 6 is a particularly suitable form of the knives 72 to which reference is made herewith explicitly. The knives 72 can each have a cutting edge which opens preferably at an angle of 30 degrees to 90 degrees, preferably 40 degrees to 50 degrees.

In the exemplary embodiment, it is provided that each of the knives 72 is fastened to a linear unit 73 which is preferably operated pneumatically, electrically or hydraulically, in particular in such a manner as is shown in detail in FIGS. 4 to 6. The knives 72 can each be moved radially outward with the aid of the linear units 73. The radial movement of the knives 72 is relative to the center of a support surface 74 or to the center of the planar element 3 that is placed on the support surface 74 of the unpacking station 70.

The linear units 73 are preferably each disposed at an angle of 90° to the respectively adjacent linear units 73, so that the knives 72 are moved radially outward at an angle of 90°. The movement of the knives 72 herein runs plane-parallel to the support surface 74, or the upper side 3b, or the lower side 3a of the planar element 3. The knives 72 preferably move below the packaging 301 into a region between the lower side of the pack 300 and the packaging 301, and cut open the packaging 301.

A particularly advantageous design of the third multi-axis robot 21 is derived in particular from FIGS. 3 and 4. It is illustrated that the multi-axis robot 21 has a plurality of receptacle elements 23 which are suitable for picking up or holding the packaging 301. The receptacle elements 23 can be formed as a tappet or as suction cups. Preferably, six suction cups can be provided, which are suitable for lifting the packaging 301 by suction. It is also possible to form the receptacle elements 23 in such a manner that they pick up the packaging 301 mechanically. It is provided that the third multi-axis robot 21, with the aid of the receptacle elements 23, lifts the packaging 301 from the pack 300 after the knives 72 have cut the packaging 301. The multi-axis robot 21 then moves the packaging 301 preferably to the transport cart 20 or another container, or a collection point in which the packaging 301 can be received and then disposed of.

The third multi-axis robot 21 is preferably designed in such a manner that it has a gripping apparatus 24. The gripping apparatus 24 preferably has two grippers 25, which are able to be moved or clamped linearly relative to one another, and between which a tile pack 300 can be picked up and fixed. The grippers 25 are preferably designed in such a manner that they embrace in each case the pack 300 on its upper side and lower side.

The unpacking station 70 preferably has a vacuum unit 75 which holds the pack 300 in position after the latter is placed on the support surface 74.

The unpacking station 70 preferably has a vertical column 76 which is preferably tubular and has at its upper end the support surface 74. Below the support surface 74, in each case offset by 90°, the linear units 73 protrude in the radial direction in terms of the horizontally extending longitudinal axis of the vertical column 76.

The vacuum unit 75 is preferably disposed or designed in such a manner that a suction opening or a suction plate is formed at the upper end of the vertical column 76, which is part of the support surface 74 or forms the support surface 74. The suction effect is preferably generated inside the tubular vertical column 76.

It should be mentioned again that the unpacking station 70 represents an independent invention to remove a packaging 301 from a pack 300 which has a plurality of planar elements 3, in particular tiles. This applies in particular in conjunction with the multi-axis robot 21.

The lifting-and-turning apparatus 50 preferably has a gripping apparatus 51 to pick up the planar element 3. The gripping apparatus 51 has a horizontally extending horizontal beam 52. Disposed on the horizontal beam 52 are two gripping units 53 which can be moved linearly toward and away from one another. A common drive is preferably provided for moving the two gripping units 53. The gripping apparatus 51 is preferably designed in such a manner that the two gripping units 53 are symmetrically, in particular strictly symmetrically, movable relative to one another. The gripping units 53 are designed and disposed in such a manner that they are suitable for gripping the planar element 3, to clamp and center it between them. The gripping apparatus 51 preferably has, as is illustrated in particular in FIG. 12, a lever 54 which is movable, in particular pneumatically, hydraulically or electrically, with the aid of a linear unit 55. The linear unit 55 can be embodied in particular as a pneumatic cylinder. Two gripping arms 56 are attached to the lever 54 in such a manner that a movement of the lever 54 leads to the gripping arms 56, which are each connected to a gripping unit 53, moving the gripping units 53 toward one another or away from one another, in particular so as to clamp the planar element 3 between the gripping units 53. The gripping units 53 are preferably moved by a common drive.

The gripping apparatus 51, or the horizontal beam 52, is mounted in a rotating unit 57. The rotating unit 57 is preferably designed in such a manner that it allows a rotation of the horizontal beam 52 by 180°. For this purpose, the rotating unit 57 has a rotatable ring, in particular a rolling bearing, preferably a large-diameter rolling bearing 58, as illustrated in FIGS. 8 to 12. The horizontal beam 52 is disposed within the large-diameter rolling bearing 58.

It has proven to be advantageous when the large-diameter rolling bearing 58 enables only a revolution by 180°, and in particular no complete rotation by 360° and also no rotation by up to 270°, in particular so that pneumatic or hydraulic connections for operating the gripping apparatus 51 can easily fed in.

The lifting-and-turning apparatus 50 furthermore has a lifting unit 59 which enables the gripping apparatus 51 or the rotating apparatus 57 to move in the vertical direction, so that the gripping apparatus 51 can lift a planar element 3 resting on the conveyor belt 14. FIGS. 9 to 11 show the gripping apparatus 51 in a lifted position, in which the feeding apparatus, in particular the second multi-axis robot 15, can then pick up the planar element 3. The lifting unit 59 preferably has one, two, or more than two, linear axes or ball screw spindles to lift the gripping apparatus 51 or the rotating apparatus 57.

In the exemplary embodiment it is provided that the rotating apparatus 57 causes a rotation of the planar element 3 by 180°, while the lifting apparatus 59 carries out a lifting movement or while the lifting apparatus 59 lifts the planar element 3. This reduces the cycle time. In FIGS. 9 to 11, the planar element 3 is illustrated with the lower side 3a oriented downward, i.e. the turning process is completed. The planar element 3 is lifted up to the upper position of the lifting unit 59 and is available to the second multi-axis robot 15. The planar element 3 can be picked up from above by the second multi-axis robot 15, preferably with the aid of suction cups.

It should be pointed out again that the lifting-and-turning apparatus 50 represents an independent invention to pick up a planar element 3 and to lift it and turn it about 180°, so that an originally upwardly oriented side of the planar element 3, in the exemplary embodiment the lower side 3a of the planar element 3, is oriented downward after the turning process.

For the production of a composite body 1 it is preferably provided that a pack 300 with planar elements 3 is delivered to the storage station 18. The third multi-axis robot 21 can then preferably pick up one of the packs 300 from the storage station 18 and place them on the unpacking station 70. This is illustrated in principle in FIGS. 1 to 3.

In the unpacking station 70, the packaging 301 of the pack 300 is cut, preferably only along the lower side of the pack, in each case up to the vertically extending corners or the vertical edges, and removed. The pack 300 with the planar element 3 preferably rests on the unpacking station 70 in such a manner that a lower side 3a of the planar element 3 is oriented upward.

The unpacking station 70 is illustrated in detail in FIGS. 4 to 6.

FIG. 4 shows by way of example a pack 300 which rests on the unpacking station 70, in which an uppermost tile 3 with the lower side 3a is oriented upward.

FIGS. 1, 2 and 7 show a first multi-axis robot 13 (or generally an onward transport apparatus) which is suitable for picking up in each case the uppermost planar element 3 of a pack 300, which rests on the unpacking station 70, and placing it on a support surface, preferably the conveyor belt 14. The planar element 3 is placed on the conveyor belt 14 in such a manner that a lower side 3a of the planar element 3 is oriented upward.

The onward transport apparatus, in particular the multi-axis robot 13, is positioned in such a manner that it can pick up a planar element 3 from the unpacking station 70 and place it on the conveyor belt 14.

The multi-axis robot 13 picks up in each case the uppermost planar element 3 from the pack 300 until all planar elements 3 of the pack 300 are placed on the conveyor belt 14.

As can be seen from FIGS. 7 and 8, the planar element 3 is conveyed below the adhesive application apparatus 12 with the aid of the conveyor belt 14. In the process, the adhesive 4 is applied by the adhesive application apparatus 12 to the lower side 3a of the planar element 3. After the planar element 3 has been conveyed below the adhesive application apparatus 12, the planar element 3 is preferably picked up by the lifting-and-turning apparatus 50, lifted and turned by 180° in such a way that the lower side 3a of the planar element 3 is oriented downward.

The lifting-and-turning apparatus 50 is illustrated in detail in FIGS. 8 to 12.

After the lifting-and-turning apparatus 50 has lifted the planar element 3 and turned it in such a manner that the lower side 3a of the planar element 3 is oriented downward, the feeding apparatus, which is preferably formed as a second multi-axis robot 15, picks up the planar element 3 and moves it to the concrete body provisioning apparatus 16, in which preferably green-stable concrete bodies 2 are located.

The upper sides 2b of the concrete bodies 2, which are located in the concrete body provisioning apparatus 16, are oriented upward. It is illustrated in FIGS. 1, 2 and 13 how the second multi-axis robot 15 presses the lower side 3a of the planar element 3 onto the upper side 2b of one of the concrete bodies 2. As illustrated by way of example in FIG. 13, the concrete body provisioning apparatus 16 is supplied with concrete bodies 2, which originate from a concrete body production apparatus 8, or are transported from there.

Once the planar element 3 has been adhesively bonded to the concrete body 2 and thus a composite body 1 has been formed, the concrete body 2 or the thus formed composite body 1 is preferably supplied to a curing area, in particular a curing chamber 11, which is illustrated only by way of example in FIG. 13.

The multi-axis robots 13, 16, 21 are preferably 6-axis robots.

It should be noted that other handling apparatuses can also be provided instead of the multi-axis robots. It should also be noted that two or more multi-axis robots can also in each case be used instead of a multi-axis robot, i.e. that, for example, two first multi-axis robots are provided.

It should also be noted that the exemplary embodiment is to be understood in such a manner that individual method steps or stations can be otherwise designed or omitted as well. For example, the storage station 18 can thus also be omitted and the packs 300 can be placed directly on the unpacking station 70.

It should also be noted that a plurality of unpacking stations 70, preferably two (as illustrated in the exemplary embodiment), or more than two, unpacking stations 70 can also be provided.

It should also be noted that a plurality of adhesive application apparatuses 12, preferably two or three adhesive application apparatuses 12, can also be provided, as well as a corresponding number of lifting-and-turning apparatuses 50 and conveyor belts 14.

What is claimed is:

1. A method for producing a composite body which comprises a concrete body and a planar element, whereupon a lower side of the planar element is adhesively bonded to an upper side of the concrete body by means of an adhesive, and wherein an upper side of the planar element forms an upper side of the composite body,
wherein the planar element is disposed on a support surface in such a manner that the lower side of the planar element is oriented upward for applying the adhesive, whereupon the adhesive is applied in an automated manner to at least a sub-region of the lower side of the planar element, and the planar element is subsequently lifted in an automated manner from the support surface and turned over in such a manner that the lower side of the planar element is oriented downward, whereupon the planar element is moved to the concrete body and is in this orientation pressed onto the upper side of the concrete body from above.

2. The method as claimed in claim 1, wherein pressing the planar element onto the concrete body is carried out in a green-stable state of the concrete body, in which the concrete body is dimensionally stable, but not yet cured.

3. The method as claimed in claim 2, wherein the planar element is moved plane-parallel and/or orthogonal relative to the upper side of the concrete body during pressing onto the concrete body.

4. The method as claimed in claim 1, wherein the planar element is moved so as to vibrate and/or oscillate relative to the surface of the concrete body during pressing.

5. The method as claimed in claim 1, wherein the planar element is transported below an adhesive application apparatus in such a manner that the adhesive is applied from above, preferably with a toothed spatula structure, to the lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction.

6. The method as claimed in claim 1, wherein the lower side of the planar element is cleaned of dust before applying the adhesive, in particular blown off and/or brushed off.

7. The method as claimed in claim 1, wherein the position of the concrete body is determined, preferably measured, before pressing the planar element.

8. The method as claimed in claim 1, wherein the position of an entire production layer of concrete bodies is measured, preferably in that two diagonally opposite corner points of the production layer are measured.

9. The method as claimed in claim 1, wherein after the adhesive has been applied to the lower side of the planar element and the planar element has been turned in such a manner that the lower side of the planar element is oriented downward, the planar element is picked up by a feeding apparatus, in particular a second multi-axis robot, in particular a 6-axis robot, moved to the concrete body and pressed onto the concrete body.

10. The method as claimed in claim 1, wherein the planar element is adhesively bonded to the concrete body while the concrete body is still in a production mold in which the concrete body is compacted, or the planar element is adhesively bonded to the concrete body once the concrete body has left a production mold in which the concrete body is compacted.

11. The method as claimed in claim 1, wherein after adhesively bonding the planar element, the concrete body is fed to a curing area, preferably a curing chamber, which has a higher temperature and in which the concrete body cures.

12. The method as claimed in one of claim 1, wherein the planar element is provided as part of a pack of similar planar elements which are disposed stacked on top of one another conjointly in a packaging, whereupon the pack, preferably by means of a third multi-axis robot, in particular a 6-axis robot, is placed on an unpacking station, whereupon the packaging is cut open and removed in the unpacking station, and the respectively uppermost planar element of the pack is removed, preferably by means of an onward transport apparatus, in particular a first multi-axis robot, in particular a 6-axis robot, and is placed on the support surface, preferably a conveyor belt, in such a manner that the lower side of the planar element is oriented upward.

13. The method as claimed in one of claim 1, wherein the planar element is formed as a slab, in particular as a ceramic slab, rubber slab, vinyl slab, checker board, stainless steel slab or metal slab, in particular with a structured upper side, and/or as a tile, as a natural stone or as a laminate.

14. A device for producing a composite body which has a concrete body and a planar element, wherein a lower side of the planar element is adhesively bonded to an upper side of the concrete body by means of an adhesive, and an upper side of the planar element forms an upper side of the composite body,
a support surface on which the planar element is disposed in such a manner that the lower side of the planar element is oriented upward, and having an adhesive application apparatus which subsequently applies an adhesive to at least a sub-region of the upwardly oriented lower side of the planar element, and having a lifting-and-turning apparatus to subsequently lift the planar element from the support surface and turn it in such a manner that the lower side of the planar element is oriented downward, and having a feeding apparatus in order to subsequently move the planar element provided with the adhesive to the concrete body, and to press the lower side of the planar element onto the upper side of the concrete body.

15. The device as claimed in claim 14, wherein a concrete body provisioning apparatus is provided, in which the concrete body is preferably in a green-stable state in which the concrete body is dimensionally stable, but not yet cured, and wherein the feeding apparatus is positioned relative to the lifting-and-turning apparatus and the concrete body provisioning apparatus in such a manner that the planar element is able to be picked up by the feeding apparatus from the lifting-and-turning apparatus and can be pressed from above onto the preferably green-stable concrete body provided by the concrete body provisioning apparatus.

16. The device as claimed in claim 14, wherein an activation apparatus is provided, which moves the planar element relative to the surface of the concrete body while being pressed onto the concrete body.

17. The device as claimed in claim 14, wherein a cleaning apparatus is provided in order to clean the lower side of the planar element before applying the adhesive, and/or the upper side of the concrete body before pressing the planar element, in particular in order to blow off or brush off dust.

18. The device as claimed in claim 14, characterized in that wherein a measuring apparatus is provided to determine, in particular to measure, the position of the concrete body on the concrete body provisioning apparatus.

19. The device as claimed in claim 14, wherein a curing area, in particular a curing chamber, which has a higher temperature and into which the composite body is able to be moved after adhesively bonding the planar element to the concrete body, is provided.

20. The device as claimed in claim 14, wherein for applying the adhesive to the lower side of the planar element, the support surface and the adhesive application apparatus are designed to transport the planar element below the adhesive application apparatus and in the process to apply the adhesive, preferably with a toothed spatula structure, to the upwardly oriented lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction.

21. The device as claimed in claim 14, wherein a storage station is provided, in which the planar element is kept available as part of a pack of similar planar elements which are disposed stacked on top of one another conjointly in a packaging, wherein an unpacking station is provided, and the pack is able to be moved, preferably by means of a third multi-axis robot, in particular a 6-axis robot, from the storage station to the unpacking station and is placed on a support surface of the unpacking station, wherein the unpacking station is specified to remove the packaging, and wherein an onward transport apparatus, preferably a first multi-axis robot, in particular a 6-axis robot, is provided to pick up the respectively uppermost planar element of the pack, and to place it on the support surface, preferably a conveyor belt, in such a manner that the lower side of the planar element is oriented upward.

22. The device as claimed in claim 14, wherein the planar element is a slab, in particular a ceramic slab, a rubber slab, a vinyl slab, a checker board, a stainless steel slab or a metal slab, in particular with a structured upper side, and/or the planar element is a tile, a natural stone or a laminate.

23. lifting-and-turning apparatus in particular for use in a device as claimed in claim 14, wherein the lifting-and-turning apparatus is suitable for picking up in an automated manner a planar element, in particular a tile, lying on a support surface with the lower side facing upward from the support surface, lift it by a lifting movement, and to turn it in such a manner that the lower side of the planar element is oriented downward.

24. An unpacking station in particular for use in a device as claimed in claim 14, wherein the unpacking station is suitable to pick up a pack of similar planar elements, which are stacked on top of one another and are disposed conjointly in a packaging, in particular tiles, wherein the planar element is part of the pack, and wherein the unpacking station is specified to cut open and remove the packaging so that the uppermost planar element of the pack is exposed.

25. An adhesive application apparatus in particular for use in a device as claimed in claim 14, wherein the adhesive application apparatus has an adhesive receptacle space and a dispensing opening and is designed in such a manner that the planar element is able to be transported below the adhesive application apparatus in order to apply the adhesive from the dispensing opening as the planar element is transported, preferably with a toothed spatula structure, to the upwardly oriented lower side of the planar element, wherein the adhesive application apparatus preferably has an adjustable wiping element for wiping off the adhesive applied to the lower side of the planar element from the lower side of the planar element again as required, in particular in the region of the two edges of the planar element extending transversely to the feed direction.

26. A composite body, comprising a concrete body and a planar element, wherein the composite body is produced according to a method as claimed in claim 1.
